(19) United States
(12) Patent Application Publication
(10) Pub. No.: US 2026/0335841 A1
(43) Pub. Date: Oct. 29, 2026

(54) COMPOSITE HOLLOW FIBER MEMBRANE AND METHOD FOR MANUFACTURING SAME

(71) Applicants: UNITIKA LTD., Osaka-shi, Osaka (JP); NATIONAL UNIVERSITY CORPORATION KOBE UNIVERSITY, Kobe-shi, Hyogo (JP)

(72) Inventors: Ryota NAKAMURA, Uji-shi (JP); Kuniko INOUE, Uji-shi (JP); Tatsunori MASAKI, Uji-shi (JP); Kyohei UMAKOSHI, Uji-shi (JP); Miho HIRAI, Uji-shi (JP); Noriaki KATO, Kobe-shi (JP); Hideto MATSUYAMA, Kobe-shi (JP)

(73) Assignees: UNITIKA LTD., Osaka-shi, Osaka (JP); NATIONAL UNIVERSITY CORPORATION KOBE UNIVERSITY, Kobe-shi, Hyogo (JP)

(21) Appl. No.: 19/471,822

(22) PCT Filed: Mar. 29, 2024
(86) PCT No.: PCT/JP2024/013298

§ 371 Date: Oct. 2, 2025

(30) Foreign Application Priority Data
Apr. 3, 2023 (JP) 2023-060019

(51) Int. Cl. B01D 71/56; B01D 63/02; B01D 69/10; B01D 69/12; B01D 71/24

(52) U.S. Cl. CPC B01D 71/56; B01D 63/02; B01D 69/10; B01D 69/1216; B01D 71/24; B01D 2325/04

(57) ABSTRACT

The purpose of the present invention is to provide: a composite hollow fiber membrane, in which the liquid permeability of an organic solvent and the rejection ability of a solute in an organic solvent-based liquid to be treated are both achieved to a great extent; and a method for manufacturing the same. This composite hollow fiber membrane includes: a polyamide hollow fiber membrane having a dense layer and a support layer; and a silicone layer. The silicone layer is provided on the surface of the dense layer.

### TECHNICAL FIELD

The present invention relates to a composite hollow fiber membrane including a polyamide hollow fiber membrane having a dense layer and a support layer, and a silicone layer, and a method for manufacturing the composite hollow fiber membrane.

### BACKGROUND ART

In recent years, from the viewpoint of construction of a sustainable society and achievement of carbon neutrality, a process that saves more energy is required in the chemical industry. In particular, the distillation process occupies a high proportion of energy consumed in the entire chemical industry. Thus, conversion to a process that saves more energy is required, and conversion to a membrane separation process which is a process that saves more energy is being studied.

The membrane separation process is used in the field of water purification and the manufacturing process for various industrial products using water as a solvent, and is an industrially established technique. As a material of the separation membrane used in a membrane separation process, a polymer membrane is mainly used because of relatively easy molding processing, ease of establishment of an inexpensive mass production process, and ease of handling because of its light weight and flexibility.

On the other hand, in the chemical industry, an organic solvent is mainly used as a solvent, and thus a material of the separation membrane is required to have solvent resistance. For example, in the manufacture of semiconductors or liquid crystal panels, glycol ether-based solvent such as propylene glycol monomethyl ether, 3-methoxybutanol, propylene glycol monomethyl ether acetate, 3-methoxybutyl acetate, dipropylene glycol monomethyl ether acetate, diethylene glycol monoethyl ether, and diethylene glycol monobutyl ether; cyclic ketones such as cyclohexanone; aprotic polar solvents such as dimethyl sulfoxide and N-methylpyrrolidone, and the like are used as a photoresist chemical solution, a cleaning liquid, and a stripping liquid used for forming a wiring pattern. To substitute the membrane separation process for the distillation process, the material of the separation membrane needs to be resistant to these organic solvents.

In addition, to substitute the membrane separation process for the distillation process, a separation membrane having separation performance of nanofiltration level, capable of separating a solute in an organic solvent-based liquid to be treated, in particular, a solute having a molecular weight of about 200 to 1000, is required.

Under such circumstances, it has been studied to obtain a nanofiltration membrane through a technique called thermally induced phase separation (TIPS) using a polyamide resin having high resistance to the various organic solvents. The TIPS method is a relatively new method, and is a method including selecting a solvent that does not dissolve a polymer material at a low temperature but dissolves it at a high temperature, cooling a uniform polymer solution in which the polymer material is dissolved at a high temperature to a temperature equal to or lower than a binodal line which is a boundary between a one-phase region and a two-phase region to induce phase separation, and fixing the structure through crystallization or glass transition of the polymer. Since the TIPS method can also be applied to a polymer having no solvent that dissolves the polymer at a low temperature, the TIPS method can be applied to a resin having high solvent resistance, and because a sponge-like homogeneous structure tends to be formed and a high-strength separation membrane is obtained, a pressure that is a driving force for liquid permeation can be applied at a high pressure in a nanofiltration membrane in which the liquid permeation amount is reduced because of a small pore diameter. Thus, the TIPS method is a suitable method for obtaining a nanofiltration membrane having solvent resistance.

For example, patent literature 1 proposes a nanofiltration hollow fiber membrane that is manufactured by the TIPS method and is formed using a polyamide resin, has a molecular weight cut-off of 200 to 1000 and a methanol permeation amount of 0.03 L/(m²·bar·h) or more.

Patent literature 2 proposes a polyamide hollow fiber membrane that is manufactured by applying the TIPS method, has a dense layer formed on at least one surface, has a streaky recess extending in one direction on a surface of the dense layer, and is used as an ultrafiltration membrane or a nanofiltration membrane.

### CITATION LIST

### Patent Literature

Patent Literature 1: WO 2022/071123 A
Patent Literature 2: WO 2022/071122 A

### SUMMARY OF INVENTION

### Technical Problem

To substitute the membrane separation process for the distillation process, a separation membrane having excellent liquid permeability of the organic solvent and excellent rejection ability of the solute in an organic solvent-based liquid is required. However, the liquid permeability and the rejection ability are conflicting with each other, and thus it is very difficult to achieve both the liquid permeability and the rejection ability at a high level.

The polyamide hollow fiber membranes of patent literatures 1 and 2 have high resistance to various organic solvents, but there is room for improvement in terms of achieving both the liquid permeability and the rejection ability at a high level.

The purpose of the present invention is to provide: a composite hollow fiber membrane, in which the liquid permeability of the organic solvent and the rejection ability of the solute in an organic solvent-based liquid to be treated are both achieved at a high level; and a method for manufacturing the composite hollow fiber membrane.

### Solution to Problem

The inventors of the present invention have extensively conducted studies for achieving the object, and resultantly found that a composite hollow fiber membrane capable of achieving both the liquid permeability of the organic solvent and the rejection ability of the solute in an organic solvent-based liquid to be treated at a high level by providing a silicone layer on a surface of a dense layer of a polyamide hollow fiber membrane. The present invention has been completed by further conducting studies based on such a finding.

That is, the present invention provides inventions of the following aspects.
Item 1. A composite hollow fiber membrane including:
   a polyamide hollow fiber membrane having a dense layer and a support layer; and a silicone layer,
   wherein the silicone layer is provided on a surface of the dense layer.
Item 2. The composite hollow fiber membrane according to item 1, wherein the support layer has a porosity of 60 to 80%.
Item 3. The composite hollow fiber membrane according to item 1 or 2, wherein the dense layer has a thickness of 0.1 μm or more.
Item 4. The composite hollow fiber membrane according to any one of items 1 to 3, wherein the dense layer is provided on a lumen surface side of the polyamide hollow fiber membrane.
Item 5. The composite hollow fiber membrane according to any one of items 1 to 4, wherein the silicone layer has a thickness of 0.2 to 10 μm.
Item 6. The composite hollow fiber membrane according to any one of items 1 to 5, wherein the silicone layer is formed of silicone rubber.
Item 7. A filtration method including filtering a liquid to be treated containing an organic solvent and a solute using the composite hollow fiber membrane according to any one of items 1 to 6.
Item 8. A hollow fiber membrane module including the composite hollow fiber membrane according to any one of items 1 to 6 housed in a module case.
Item 9. A method for manufacturing a composite hollow fiber membrane, the method including first to fourth steps described below:
   a first step of preparing a membrane-forming dope solution in which a polyamide resin is dissolved at a concentration of 20 wt % or more at a temperature of 100 °C or higher in an organic solvent having a boiling point of 150 °C or higher and incompatible with the polyamide resin at a temperature of lower than 100 °C;
   a second step of extruding the membrane-forming dope solution into a coagulation bath at 100 °C or lower in a predetermined shape to coagulate the polyamide resin into a membrane shape, wherein in the step, a coagulation liquid having compatibility with the organic solvent used in the membrane-forming dope solution and low affinity for the polyamide resin is brought into contact with at least one surface of the membrane-forming dope solution extruded in the predetermined shape to form a polyamide hollow fiber membrane having a dense layer on the at least one surface;
   a third step of removing the solvent of the membrane-forming dope solution and the coagulation liquid from the polyamide hollow fiber membrane formed in the second step; and
   a fourth step of forming a silicone layer on a surface of at least one dense layer of the polyamide hollow fiber membranes obtained by performing the third step.

### Advantageous Effects of Invention

The composite hollow fiber membrane of the present invention can achieve both the liquid permeability of the organic solvent and the rejection ability of the solute in an organic solvent-based liquid to be treated at a high level. In addition, the composite hollow fiber membrane of the present invention is formed of a polyamide resin and silicone. Thus, the composite hollow fiber membrane has excellent resistance to various types of organic solvents, and can stably maintain membrane performance even when the composite hollow fiber membrane is brought into contact with various types of organic solvents used industrially. Thus, the composite hollow fiber membrane can be suitably used for the membrane separation process as an alternative to the distillation process.

### BRIEF DESCRIPTION OF DRAWINGS

FIG. 1 is a schematic diagram of an apparatus used for measuring a molecular weight cut-off, a liquid permeation amount (Flux), and a rejection rate of a composite hollow fiber membrane or a polyamide hollow fiber membrane.

FIG. 2 a is a schematic diagram of a module used at the time of measuring a burst pressure of a composite hollow fiber membrane or a polyamide hollow fiber membrane, and b is a schematic diagram of an apparatus used for measuring a burst pressure of a composite hollow fiber membrane or a polyamide hollow fiber membrane.

FIG. 3 is an image analysis view after binarization processing for calculating the porosity of a support layer of a composite hollow fiber membrane of Example 3.

FIG. 4 is a scanning electron microscope image (magnification: 5000 times) of a lumen-side section of the composite hollow fiber membrane of Example 3.

FIG. 5 is a schematic diagram for describing an example of calculating the porosity of a support layer of a composite hollow fiber membrane, and is a schematic sectional view of a polyamide hollow fiber membrane cut in a direction perpendicular to a longitudinal direction.

FIG. 6 is a partially enlarged view of a region surrounded by the dotted line in FIG. 5.

FIG. 7 is a partially enlarged view of a region surrounded by the dotted line in FIG. 5.

### DESCRIPTION OF EMBODIMENTS

### 1. Definitions

In the present invention, “ultrafiltration” or “ultrafiltration membrane” means a filtration with a molecular weight cut-off set within a range of 1000 to 1,000,000 or a filtration membrane having a molecular weight cut-off within a range of 1000 to 1,000,000, and “nanofiltration” or “nanofiltration membrane” means a filtration with a molecular weight cut-off set within a range of 200 to 1000 or a filtration membrane having a molecular weight cut-off within a range of 200 to 1000.

In the present invention, “polyamide hollow fiber membrane” means a hollow-fiber-shaped filtration membrane formed using a polyamide resin, the filtration membrane including a dense layer and a support layer.

In the present invention, “dense layer” means a region where dense micropores are gathered in a polyamide hollow fiber membrane and where substantially no pores are observed in a scanning electron microscope (SEM) photograph at a magnification of 10,000 times.

In the present invention, “support layer” means a region other than the dense layer in a polyamide hollow fiber membrane and where pores are substantially observed in a scanning electron microscope (SEM) photograph at a magnification of 2,000 times, which is a porous region having a continuous porous structure.

In the present invention, “silicone layer” means a layer provided on a surface of the dense layer of the polyamide hollow fiber membrane, the layer being formed using silicone.

### 2. Composite Hollow Fiber Membrane

The composite hollow fiber membrane of the present invention includes: a polyamide hollow fiber membrane including a dense layer and a support layer; and a silicone layer, wherein the silicone layer is provided on a surface of the dense layer. Hereinafter, the composite hollow fiber membrane of the present invention will be described in detail.

### [Polyamide Hollow Fiber Membrane]

The polyamide hollow fiber membrane as a main constituent member of the composite hollow fiber membrane of the present invention includes a dense layer and a support layer, and is formed of a polyamide resin. The use of the polyamide resin as a constituent resin of the polyamide hollow fiber membrane can give the composite hollow fiber membrane of the present invention a resistance to a wide range of organic solvents.

The type of the polyamide resin is not particularly limited, and examples thereof include a homopolymer of polyamide, a copolymer of polyamide, and a mixture thereof. Specific examples of the homopolymer of polyamide include polyamide 6, polyamide 66, polyamide 46, polyamide 610, polyamide 612, polyamide 11, polyamide 12, polyamide MXD6, polyamide 4T, polyamide 6T, polyamide 9T, and polyamide 10T. Specific examples of the copolymer of polyamide include copolymers of polyamide and polyether such as polytetramethylene glycol or polyethylene glycol. The ratio of the polyamide component in the copolymer of polyamide is not particularly limited, but for example, the proportion of the polyamide component is preferably 70 mol % or more, more preferably 80 mol % or more, still more preferably 90 mol % or more, and particularly preferably 95 mol % or more. When the ratio of the polyamide component in the copolymer of polyamide satisfies the above range, the polyamide hollow fiber membrane can have more excellent organic solvent resistance. The polyamide resins may be used singly, or may be used in combination of two or more thereof.

Among these polyamide resins, polyamide 6 is preferably used as a resin for forming the polyamide hollow fiber membrane because it is easy to suitably achieve both the pressure resistance and the solvent resistance and it is easy to improve the liquid permeability of the organic solvent.

The polyamide resin may be crosslinked or not, but is preferably not crosslinked from the viewpoint of reducing the manufacturing cost.

The relative viscosity of the polyamide resin is not particularly limited, and is, for example, 2.0 to 7.0, preferably 2.5 to 6.0, more preferably 3.0 to 5.0. When the polyamide hollow fiber membrane has such a relative viscosity, moldability and controllability of phase separation are improved at the time of manufacturing the polyamide hollow fiber membrane, and thus, the polyamide hollow fiber membrane can have excellent shape stability. Here, the relative viscosity refers to a value measured with an Ubbelohde viscometer at 25 °C using a solution obtained by dissolving 1 g of a polyamide resin in 100 mL of 96% sulfuric acid.

In addition to the polyamide resin, the polyamide hollow fiber membrane may contain a filler as necessary as long as the effect of the present invention is not impaired. By containing a filler, the strength, elongation, and elastic modulus of the polyamide hollow fiber membrane can be improved. In particular, by containing a filler, an effect that the polyamide hollow fiber membrane is hardly deformed even when a high pressure is applied during filtration is also obtained. The type of filler to be added is not particularly limited, and examples thereof include fibrous fillers such as glass fibers, carbon fibers, potassium titanate whiskers, zinc oxide whiskers, calcium carbonate whiskers, wollastonite whiskers, aluminum borate whiskers, aramid fibers, alumina fibers, silicon carbide fibers, ceramic fibers, asbestos fibers, gypsum fibers, and metal fibers; silicates such as talc, hydrotalcite, wollastonite, zeolite, sericite, mica, kaolin, clay, pyrophyllite, bentonite, asbestos, and alumina silicate; metal compounds such as silicon oxide, magnesium oxide, alumina, zirconium oxide, titanium oxide, and iron oxide; carbonates such as calcium carbonate, magnesium carbonate, and dolomite; sulfates such as calcium sulfate and barium sulfate; metal hydroxides such as calcium hydroxide, magnesium hydroxide, and aluminum hydroxide; and inorganic materials such as non-fiber fillers including glass beads, glass flakes, glass powder, ceramic beads, boron nitride, silicon carbide, carbon black, silica, and graphite. These fillers may be used singly, or may be used in combination of two or more thereof. Among these fillers, talc, hydrotalcite, silica, clay, and titanium oxide are preferable, and talc and clay are more preferable. The content of the filler is not particularly limited, and is, for example, 5 to 100 parts by weight, preferably 10 to 75 parts by weight, more preferably 25 to 50 parts by weight per 100 parts by weight of the polyamide resin. By containing the filler with such a content, the strength, elongation, and elastic modulus of the polyamide hollow fiber membrane can be improved.

The polyamide hollow fiber membrane may contain additives such as a thickener, an antioxidant, a surface modifier, a lubricant, and a surfactant as necessary for controlling the pore size and improving the membrane performance.

The outer diameter of the polyamide hollow fiber membrane is appropriately set according to the application of the polyamide hollow fiber membrane, the thicknesses of the dense layer and the support layer, the liquid permeability to be provided, and the like, but the outer diameter of the hollow fiber membrane is 400 μm or more, preferably 450 to 4000 μm, more preferably 500 to 3500 μm in view of the relationship with the effective membrane area when filled in a module, the membrane strength, the pressure loss of the fluid flowing in the hollow portion, and the buckling pressure. The inner diameter of the polyamide hollow fiber membrane is not particularly limited, and is, for example, 100 to 3000 μm, preferably 200 to 2500 μm, more preferably 300 to 2000 μm, and still more preferably 300 to 1500 μm. In the present invention, the outer diameter and the inner diameter of the polyamide hollow fiber membrane are values determined by observing five composite hollow fiber membranes with an optical microscope at a magnification of 200 times, measuring the outer diameter and the inner diameter (at the portion having a maximum diameter) of the polyamide hollow fiber membrane constituting each of the composite hollow fiber membranes, and calculating the average for each of the outer diameter and the inner diameter.

The thickness of the polyamide hollow fiber membrane is appropriately set according to the application of the polyamide hollow fiber membrane, the thicknesses of the dense layer and the support layer, liquid permeability to be provided, and the like, and is, for example, 50 to 600 μm, preferably 100 to 350 μm. In the present invention, the thickness of the polyamide hollow fiber membrane is a value calculated by dividing the value obtained by subtracting the inner diameter from the outer diameter by 2.

Here, filtration membranes (separation membranes) are classified into a microfiltration (MF) membrane, an ultrafiltration (UF) membrane, a nanofiltration (NF) membrane, and a reverse osmosis (RO) membrane in descending order of the size of the separation target, and in the UF membrane and smaller filtration membranes, the molecular weight cut-off is used as an index of the size of the substance to be captured. The molecular weight cut-off is determined in a permeation test using a standard substance having a known molecular weight. The molecular weight cut-off is determined from the lower molecular size (in Daltons: Da) at which 90% or more is held in the permeation test. In the present invention, the ultrafiltration membrane has a molecular weight cut-off of 1000 to 1,000,000, and the nanofiltration membrane has a molecular weight cut-off of 200 to 1000.

The polyamide hollow fiber membrane is preferably an ultrafiltration membrane or a nanofiltration membrane from the viewpoint of obtaining the composite hollow fiber membrane of the present invention capable of achieving both the liquid permeability of the organic solvent and the rejection ability of the solute in an organic solvent-based liquid to be treated at a high level. The molecular weight cut-off of the polyamide hollow fiber membrane is not particularly limited, and can be adjusted to a desired value by appropriately adjusting the thickness of the dense layer, the pore diameter of the pores of the support layer, and the like. From the viewpoint of obtaining the composite hollow fiber membrane of the present invention capable of achieving both the liquid permeability of the organic solvent and the rejection ability of the solute in an organic solvent-based liquid to be treated at a higher level, the molecular weight cut-off of the polyamide hollow fiber membrane is preferably 1000 to 120,000, more preferably 1000 to 100,000, still more preferably 1000 to 60,000, and further preferably 1000 to 50,000 in the case of an ultrafiltration membrane, and is preferably 200 to 1000, more preferably 400 to 1000, and still more preferably 600 to 1000 in the case of a nanofiltration membrane.

In the present invention, when the molecular weight cut-off of the polyamide hollow fiber membrane is more than 3000, the molecular weight cut-off is a value determined by using dextran as a standard substance and water as a solvent. Specifically, the molecular weight cut-off (when larger than 3000) of the polyamide hollow fiber membrane is a value determined by producing a crossflow module using the polyamide hollow fiber membrane and using an aqueous solution containing dextran of a plurality of known molecular weights at predetermined concentrations as a circulation liquid (feed solution) by an internal pressure crossflow method. The concentration of dextran in the permeate is measured by high performance liquid chromatography, the solute rejection rate at each molecular weight is calculated according to the following formula, the results are plotted on a graph showing the molecular weight on the horizontal axis and the rejection rate on the vertical axis, and the molecular weight cut-off is determined as the molecular weight at the intersection of the resulting approximate curve obtained and the rejection rate of 90%.

Solute rejection rate (%)={(dextran concentration in feed solution−dextran concentration in permeate)/dextran concentration in feed solution}×100

In the present invention, when the molecular weight cut-off of the polyamide hollow fiber membrane is 3000 or less, the molecular weight cut-off is a value determined by using monodisperse polystyrene as a standard substance and N-methyl-2-pyrrolidone (hereinafter, it may also be referred to as “NMP”) as a solvent. Specifically, the molecular weight cut-off (when 3000 or less) of the polyamide hollow fiber membrane is a value determined by producing a crossflow module using the polyamide hollow fiber membrane and using an NMP solution containing polystyrene of a plurality of known molecular weights at predetermined concentrations as a circulation liquid (feed solution) by an internal pressure crossflow method. The concentration of polystyrene in the permeate is measured by high performance liquid chromatography, the solute rejection rate at each molecular weight is calculated according to the following formula, the results are plotted on a graph showing the molecular weight on the horizontal axis and the rejection rate on the vertical axis, and the molecular weight cut-off is determined as the molecular weight at the intersection of the resulting approximate curve obtained and the rejection rate of 90%.

Solute rejection rate (%)={(polystyrene concentration in feed solution−polystyrene concentration in permeate)/polystyrene concentration in feed solution}×100

The burst pressure of the polyamide hollow fiber membrane is not particularly limited, and can be adjusted to a desired value by appropriately adjusting the thickness of the dense layer, the thickness of the support layer, the pore diameter of pores of the support layer, and the like, but is preferably 10 bar or more, more preferably 15 bar or more, still more preferably 20 bar or more, and further still more preferably 25 bar or more from the viewpoint of increasing the operating pressure at the time of membrane filtration to increase the liquid permeation amount. The upper limit value of the burst pressure of the polyamide hollow fiber membrane is usually 40 bar or less, and preferably 35 bar or less. In the present invention, the burst pressure of the polyamide hollow fiber membrane is a pressure (bar) at which the hollow fiber membrane in a module produced using the polyamide hollow fiber membrane ruptures with application of water pressure. Specifically, the burst pressure of the polyamide hollow fiber membrane is preferably 10 to 40 bar, more preferably 15 to 35 bar, still more preferably 20 to 35 bar, and further still more preferably 25 to 35 bar.

Specifically, the burst pressure of the polyamide hollow fiber membrane is measured by the following method. First, the module 8 illustrated in a of FIG. 2 is produced. Specifically, first, a bundle in which 10 hollow fiber membranes 8a cut into a length of 30 cm are put together is prepared. Next, a nylon hard tube 8b having an outer diameter of 8 mm, an inner diameter of 6 mm, and a length of 50 mm is prepared, and a rubber plug having a length of about 20 mm is inserted from one end opening of the tube to plug the one end opening. Next, a two-liquid mixing type epoxy resin is injected from the opening of the tube on the side opposite to the side where the rubber plug is provided, and the tube inner space is filled with the epoxy resin. Thereafter, the prepared bundle of the hollow fiber membranes is bent into a substantially U shape, both ends of the hollow fiber membranes are thermally sealed so that the epoxy resin does not enter the hollow portion, the bundle is inserted into the tube filled with the epoxy resin until the tip of the end comes into contact with the rubber plug, and the epoxy resin is cured as it is. Then, a region on the rubber plug side of the cured epoxy resin portion is cut together with the tube. Whereby the module 8 in which hollow portions at both ends of the hollow fiber membranes are open is produced.

Next, the module 8 is set in the apparatus illustrated in b of FIG. 2, water pressure is applied to the module 8 with a hand pump 9. The pressure (bar) at which the module ruptures is defined as the burst pressure.

### [Dense Layer]

The dense layer is a region where dense micropores are gathered in the polyamide hollow fiber membrane and where substantially no pores are observed in a scanning electron microscope (SEM) photograph at a magnification of 10,000 times.

The dense layer may be formed on the lumen-side surface of the polyamide hollow fiber membrane, may be formed on the outer surface of the polyamide hollow fiber membrane, or may be formed on both surfaces of the polyamide hollow fiber membrane, but is preferably formed on the lumen-side surface from the viewpoint of achieving both the liquid permeability of the organic solvent and the rejection ability of the solute in an organic solvent-based liquid to be treated at a higher level. When the dense layer is present on the outer surface of the polyamide hollow fiber membrane in the observation of the dense layer with a scanning electron microscope (SEM), the observation may be performed by cutting the polyamide hollow fiber membrane into an appropriate size, placing the polyamide hollow fiber membrane on a sample stage, and then subjecting a vapor deposition treatment of Pt, Au, Pd, or the like to the polyamide hollow fiber membrane. When the dense layer is present on the lumen-side surface of the polyamide hollow fiber membrane, the observation may be performed by cutting the polyamide hollow fiber membrane in a longitudinal direction with a sharp bladed object such as a surgical knife, exposing and then cutting the lumen-side surface into an appropriate size, placing the polyamide hollow fiber membrane on a sample stage, and then subjecting a vapor deposition treatment of Pt, Au, Pd, or the like on the polyamide hollow fiber membrane.

The thickness of the dense layer is not particularly limited, and can be adjusted to an intended value by appropriately adjusting the solvent, concentration, and temperature of the membrane-forming dope solution, the type and temperature of the coagulation liquid, and the like, but is preferably 0.1 μm or more, more preferably 0.2 μm or more, and still more preferably 0.3 μm or more from the viewpoint of improving the rejection ability of the solute in an organic solvent-based liquid to be treated, and is preferably 2.0 μm or less, more preferably 1.8 μm or less, still more preferably 1.5 μm or less, further still more preferably 1.2 μm or less, and further still more preferably 1.0 μm or less from the viewpoint of improving the liquid permeability of the organic solvent. Specifically, the thickness of the dense layer is preferably 0.1 to 2.0 μm, more preferably 0.2 to 1.8 μm, still more preferably 0.3 to 1.5 μm, further still more preferably 0.3 to 1.2 μm, and further still more preferably 0.3 to 1.0 μm. In the present invention, the thickness of the dense layer is a value determined by measuring, the distance (thickness) of the region where substantially no pores of the polyamide hollow fiber membrane constituting the composite hollow fiber membrane are observed is measured at 10 points at regular intervals in a section of the composite hollow fiber membrane in a scanning electron microscope (SEM) photograph at a magnification of 10,000 times, and calculating the average value thereof.

### [Support Layer]

The support layer is a region other than the dense layer in the polyamide hollow fiber membrane and where pores are substantially observed in a scanning electron microscope (SEM) photograph at a magnification of 2,000 times, which is a porous region having a continuous porous structure.

The pore size of the pores of the support layer is not particularly limited as long as the pore size does not significantly interfere with the strength to hold the dense layer and the fluid permeation.

The porosity of the support layer is not particularly limited, and can be adjusted to a desired value by appropriately adjusting the solvent, concentration, and temperature of the membrane-forming dope solution, the type and temperature of the coagulation liquid, and the like in the manufacture of the polyamide hollow fiber membrane, and is preferably 60 to 80%, more preferably 63 to 78%, still more preferably 65 to 77%, and further still more preferably 66 to 76% from the viewpoint of ease of membrane formation and from the viewpoint of increasing the membrane strength so that the operating pressure at the time of membrane filtration can be increased to increase the liquid permeation amount.

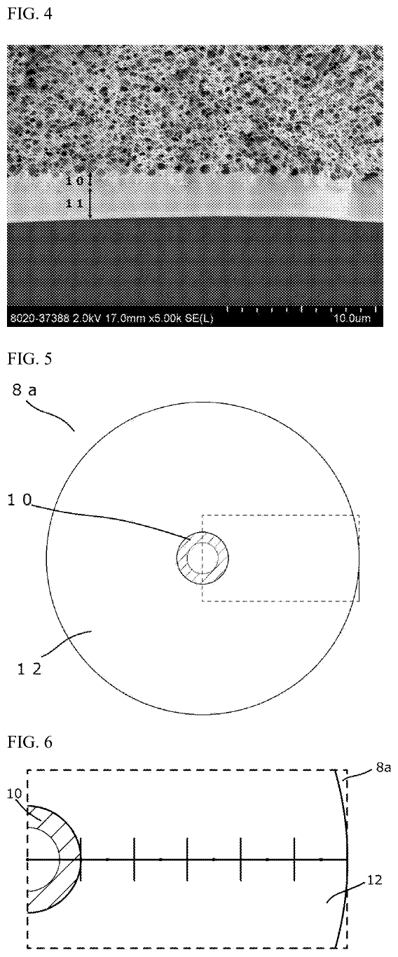

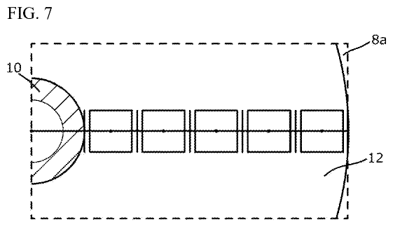

In the present invention, the porosity of the support layer is calculated by the following method. In a section of the composite hollow fiber membrane cut in a direction perpendicular to a longitudinal direction, scanning electron microscope (SEM) photographs of five points at equal intervals are taken in a thickness direction of the support layer of the polyamide hollow fiber membrane. Specifically, the photographs are taken as follows. FIG. 5 is a schematic sectional view of a polyamide hollow fiber membrane cut in a direction perpendicular to a longitudinal direction, and FIGS. 6 and 7 are partially enlarged views of a region surrounded by the dotted line in FIG. 5, showing an example of a polyamide hollow fiber membrane 8a including a dense layer 10 and a support layer 12. In FIGS. 5 to 7, the description of the silicone layer is omitted. As shown in FIG. 6, a straight line is drawn from the center of the lumen of the polyamide hollow fiber membrane 8a toward the outer surface, and the straight line is divided into five equal parts from the lumen-side surface to the outer surface of the support layer 12. Then, as illustrated in FIG. 6, the midpoint of each line segment divided into five equal parts is determined. Then, as illustrated in FIG. 7, photographs of five locations are taken at a magnification at which only the portion of the support layer 12 is included, and the number of pores is 30 to 300 with the midpoint positioned at the center of the captured image. The magnification is unified for the five locations. In the five SEM photographs that have been taken, image analysis of the region is performed using image analysis software (ImageJ), the pore portion and the polymer portion are distinguished through binarization processing, then the area ratio (%) of the total pore area to the analysis region area is calculated, and the average value thereof is calculated.

### [Silicone Layer]

The silicone layer is a layer of a non-porous region provided on a surface of the dense layer of the polyamide hollow fiber membrane to improve the rejection ability of the solute in an organic solvent-based liquid to be treated. In the composite hollow fiber membrane of the present invention having a silicone layer on a surface of the dense layer of the polyamide hollow fiber membrane, the solute rejection ability in the organic solvent-based liquid to be treated is remarkably improved as compared with a polyamide hollow fiber membrane having no silicone layer, and both the liquid permeability of the organic solvent and the rejection ability of the solute in an organic solvent-based liquid to be treated can be achieved at a high level.

The silicone layer may be provided on the surface of the dense layer on the lumen-side surface of the polyamide hollow fiber membrane or on the surface of the dense layer on the outer surface of the polyamide hollow fiber membrane, but is preferably provided on the surface of the dense layer on the lumen-side surface of the polyamide hollow fiber membrane. This is because, when a silicone layer is provided on the surface of the dense layer provided on the outer surface of the polyamide hollow fiber membrane, peeling of the silicone layer due to contact between the hollow fiber membranes at the time of filtration and peeling at the interface between both ends of the module and the sealant at the time of preparing the module may easily occur. When the polyamide hollow fiber membrane has dense layers on both surfaces thereof, the silicone layer may be provided only on a surface of either one of the dense layers, or may be provided on surfaces of both dense layers, but for the above reason, it is preferable that the silicone layer is provided only on a surface of the dense layer on the lumen-side surface.

The silicone as a material for forming the silicone layer is not particularly limited as long as it does not significantly inhibit the liquid permeability of the organic solvent and can improve the rejection ability of the solute in an organic solvent-based liquid to be treated, and may be a silicone resin or a silicone rubber. Preferably, the silicone is a silicone rubber from the viewpoint of imparting elasticity and flexibility to the silicone layer and obtaining a silicone layer excellent in shape stability.

The silicone rubber is a rubber-like cured body having a polyorganosiloxane structure obtained by curing a polyorganosiloxane. The polyorganosiloxane is a compound having a linear, branched, or network shape and having a Si—O bond (siloxane bond). The substituent bound to the silicon atom is not particularly limited, and examples thereof include an alkyl group having 1 to 10 carbon atoms, such as a methyl group, an ethyl group, a propyl group, or a butyl group; an alkenyl group having 2 to 10 carbon atoms, such as a vinyl group, an allyl group, or a butenyl group; an aryl group having 6 to 20 carbon atoms, such as a phenyl group, a tolyl group, or a naphthyl group; a cycloalkyl group having 3 to 10 carbon atoms, such as a cyclopentyl group or a cyclohexyl group. These substituents may be contained singly or in combination of two or more thereof.

Examples of the polyorganosiloxane include polydialkylsiloxane (for example, poly di C₁₋₁₀ alkylsiloxane such as polydimethylsiloxane), polyalkylalkenylsiloxane (for example, poly C₁₋₁₀ alkyl C₂₋₁₀ alkenyl siloxane such as polymethylvinylsiloxane), polyalkylarylsiloxane (for example, poly C₁₋₁₀ alkyl C₆₋₂₀ arylsiloxane such as polymethylphenylsiloxane), polydiarylsiloxane (for example, polydi-C₆₋₂₀ arylsiloxane such as polydiphenylsiloxane), dialkylsiloxane-alkylalkenylsiloxane copolymer (for example, di C₁₋₁₀ alkylsiloxane-C₁₋₁₀ alkyl C₂₋₁₀ alkenylsiloxane copolymer such as dimethylsiloxane-methylvinylsiloxane copolymer), dialkylsiloxane-alkylarylsiloxane copolymer (for example, di-C₁₋₁₀ alkylsiloxane-C₁₋₁₀ alkyl C₆₋₂₀ arylsiloxane copolymer such as dimethylsiloxane-methylphenylsiloxane copolymer), and dialkylsiloxane-alkylalkenylsiloxane-alkylarylsiloxane copolymer (for example, di C₁₋₁₀ alkylsiloxane-C₁₋₁₀ alkyl C₂₋₁₀ alkenylsiloxane-C₁₋₁₀ alkyl C₆₋₂₀ arylsiloxane copolymer such as dimethylsiloxane-methylvinylsiloxane-methylphenylsiloxane copolymer). The alkyl group of the polyorganosiloxane may be a fluorinated alkyl group. The polyorganosiloxane may be used singly, or may be used in combination of two or more thereof. Among these polyorganosiloxanes, at least one selected from the group consisting of polyalkylalkenyl siloxanes (for example, poly C₁₋₁₀ alkyl C₂₋₁₀ alkenyl siloxane such as polymethylvinylsiloxane), dialkylsiloxane-alkylalkenyl siloxane copolymers (for example, di-C₁₋₁₀ alkylsiloxane-C₁₋₁₀ alkyl C₂₋₁₀ alkenylsiloxane copolymer such as dimethylsiloxane-methylvinylsiloxane copolymer), and dialkylsiloxane-alkylalkenyl siloxane-alkylarylsiloxane copolymers (for example, di C₁₋₁₀ alkylsiloxane-C₁₋₁₀ alkyl C₂₋₁₀ alkenylsiloxane-C₁₋₁₀ alkyl C₆₋₂₀ arylsiloxane copolymer such as dimethylsiloxane-methylvinylsiloxane-methylphenylsiloxane copolymer) is preferable from the viewpoint of obtaining a silicone layer which does not significantly inhibit the liquid permeability of the organic solvent and is more excellent in the rejection ability of the solute in an organic solvent-based liquid to be treated.

The polyorganosiloxane may have a substituent such as an epoxy group, a hydroxy group, an alkoxy group, a carboxy group, an amino group, an ether group, an acryloyl group, or a methacryloyl group at a molecular terminal or the main chain. The terminal of the polyorganosiloxane is not particularly limited, and it may be, for example, a trialkylsilyl group (for example, tri-C₁₋₁₀ alkylsilyl groups such as, trimethylsilyl groups), a dialkylalkenylsilyl group (for example, di-C₁₋₁₀ alkyl C₂₋₁₀ alkenylsilyl groups such as dimethylvinylsilyl groups), a silanol group, a trialkoxysilyl group (for example, tri-C₁₋₁₀ alkoxysilyl groups such as trimethoxysilyl groups), or the like.

The polyorganosiloxane structure forming the silicone rubber may be linear, branched, or network, but is preferably linear from the viewpoint of elasticity and flexibility.

The silicone rubber may be either a one-component curing type (a type that cures by reacting with moisture in the air) or a two-component curing type (a type that cures by being mixed with a crosslinking agent), but is preferably a two-component curing type from the viewpoint of easily controlling the reaction time and excellent storage stability. The silicone rubber may be either a room temperature curing type (condensation type) or a thermal curing type (addition type), but is preferably a thermal curing type (addition type) from the viewpoint of easy reaction control.

The thermal curing type (addition type) two-component curing type silicone rubber is not particularly limited, but from the viewpoint of obtaining a silicone layer that does not significantly inhibit the liquid permeability of the organic solvent and is more excellent in the rejection ability of the solute in an organic solvent-based liquid to be treated, preferably a two-component curing type silicone rubber using the hydrosilylation reaction, more preferably a cured product of a polyorganosiloxane having an alkenyl group as a base polymer and an organohydrogenpolysiloxane (for example, polydialkylsiloxane, polyalkylarylsiloxane, or polydiarylsiloxane having a plurality of hydrogen atoms bound to a silicon atom) as a crosslinking agent, still more preferably a cured product of a base polymer of at least one selected from the group consisting of polyalkylalkenyl siloxanes (for example, poly C₁₋₁₀ alkyl C₂₋₁₀ alkenyl siloxane such as polymethylvinylsiloxane), dialkylsiloxane-alkylalkenyl siloxane copolymers (for example, di-C₁₋₁₀ alkylsiloxane-C₁₋₁₀ alkyl C₂₋₁₀ alkenylsiloxane copolymer such as a dimethylsiloxane-methylvinylsiloxane copolymer), and dialkylsiloxane-alkylalkenyl siloxane-alkylarylsiloxane copolymers (for example, di C₁₋₁₀ alkylsiloxane-C₁₋₁₀ alkyl C₂₋₁₀ alkenylsiloxane-C₁₋₁₀ alkyl C₆₋₂₀ arylsiloxane copolymer such as dimethylsiloxane-methylvinylsiloxane-methylphenylsiloxane copolymer) and the organohydrogenpolysiloxane described above.

The silicone rubber may contain a curing catalyst. The curing catalyst needs to be appropriately selected according to the type of silicone rubber, and examples thereof include an organic peroxide (for example, diacyl peroxide, peroxyester, or dialkyl peroxide), a tin salt (for example, tin soap), and a platinum group metal-based compound (for example, a platinum-based catalyst such as platinum fine powder, platinum black, chloroplatinic acid, an alcohol solution of chloroplatinic acid, a complex of platinum and olefin, a complex of platinum and alkenylsiloxane, or a platinum-phosphorus complex; or a palladium-based catalyst or a rhodium-based catalyst corresponding to these platinum-based catalysts).

The silicone layer may contain additives such as a curing retarder, a thickener, an antioxidant, a surface modifier, a lubricant, and a surfactant as necessary.

The thickness of the silicone layer is not particularly limited, but is preferably 0.2 to 10 μm, more preferably 0.5 to 8 μm, still more preferably 0.8 to 5 μm, further still more preferably 1 to 5 μm, further still more preferably 1.5 to 5 μm, and further still more preferably 2 to 5 μm from the viewpoint of suppressing generation of defects to improve the rejection ability of the solute in an organic solvent-based liquid to be treated and suppressing deterioration of the liquid permeability of the organic solvent. In the present invention, the thickness of the silicone layer is a value determined by measuring, the distance (thickness) of the non-porous region present at the surface of the dense layer is measured at 10 points at regular intervals in a section of the composite hollow fiber membrane in a scanning electron microscope (SEM) photograph at a magnification of 5000 times, and calculating the average value thereof.

### [Liquid Permeability of Organic Solvent and Rejection Ability of Solute]

In the composite hollow fiber membrane of the present invention, the silicone layer is provided on a surface of the dense layer of the polyamide hollow fiber membrane. Thus, both the liquid permeability of the organic solvent and the rejection ability of the solute in an organic solvent-based liquid to be treated can be achieved at a high level. For example, the composite hollow fiber membrane has the following liquid permeability and rejection ability.

As one embodiment of the composite hollow fiber membrane of the present invention, the NMP permeation amount at 25 °C and a pressure of 90% with respect to the burst pressure of the composite hollow fiber membrane is preferably 0.5 L/(m²·h) or more, more preferably 1.0 L/(m²·h) or more, still more preferably 1.2 L/(m²·h) or more, further still more preferably 1.5 L/(m²·h) or more, further still more preferably 2.0 L/(m²·h) or more, and further still more preferably 3.0 L/(m²·h) or more. The upper limit value of the NMP permeation amount is usually 20 L/(m²·h) or less, preferably 15 L/(m²·h) or less, more preferably 10 L/(m²·h) or less, and still more preferably 6.0 L/(m²·h) or less. Specifically, the NMP permeation amount at 25 °C and a pressure of 90% with respect to the burst pressure of the composite hollow fiber membrane is preferably 0.5 to 20 L/(m²·h), more preferably 1.0 to 15 L/(m²·h), still more preferably 1.2 to 10 L/(m²·h), further still more preferably 2.0 to 10 L/(m²·h), and further still more preferably 3.0 to 6.0 L/(m²·h). The NMP permeation amount can be adjusted to a desired value by appropriately adjusting the type of polyamide resin as a material for forming the polyamide hollow fiber membrane, the molecular weight cut-off of the polyamide hollow fiber membrane, the thickness of the dense layer, the type of silicone as a material for forming the silicone layer, the thickness of the silicone layer, and the like.

As one embodiment of the composite hollow fiber membrane of the present invention, the permeation amount of a mixed liquid of 30 wt % of propylene glycol monomethyl ether acetate and 70 wt % of propylene glycol monomethyl ether (hereinafter may be referred to as “thinner”) at 25 °C and a pressure of 90% with respect to the burst pressure of the composite hollow fiber membrane is preferably 0.5 L/(m²·h) or more, more preferably 0.8 L/(m²·h) or more, still more preferably 1.0 L/(m²·h) or more, further still more preferably 1.7 L/(m²·h) or more, further still more preferably 2.3 L/(m²·h) or more, further still more preferably 3.0 L/(m²·h) or more, and particularly preferably 4.0 L/(m²·h) or more. The upper limit value of the thinner permeation amount is usually 20 L/(m²·h) or less, preferably 15 L/(m²·h) or less, more preferably 10 L/(m²·h) or less, and still more preferably 7 L/(m²·h) or less. Specifically, the thinner permeation amount of at 25 °C and a pressure of 90% with respect to the burst pressure of the composite hollow fiber membrane is preferably 0.5 to 20 L/(m²·h), more preferably 0.8 to 15 L/(m²·h), still more preferably 1.0 to 10 L/(m²·h), further still more preferably 1.7 to 10 L/(m²·h), further still more preferably 2.3 to 10 L/(m²·h), further still more preferably 3.0 to 7.0 L/(m²·h), and particularly preferably 4.0 to 7.0 L/(m²·h). The thinner permeation amount can be adjusted to a desired value by appropriately adjusting the type of polyamide resin as a material for forming the polyamide hollow fiber membrane, the molecular weight cut-off of the polyamide hollow fiber membrane, the thickness of the dense layer, the type of silicone as a material for forming the silicone layer, the thickness of the silicone layer, and the like.

The NMP permeation amount and the thinner permeation amount are values measured through internal pressure filtration, and they are values measured through the following procedure. First, a bundle in which 20 composite hollow fiber membranes cut into a length of 30 cm are put together is prepared. Next, a polybutylene terephthalate (PBT) tube having an outer diameter of 12.7 mm, an inner diameter of 9.5 mm, and a length of 53 mm is prepared, a silicone tube having an inner diameter of 12 mm and a length of about 50 mm is inserted and connected to one end opening of the tube by about 15 mm, a rubber plug having a length of about 20 mm is inserted into the side opposite to the side where the silicone tube is inserted into the PBT tube, and the one end opening is plugged. Next, a two-liquid mixing type epoxy resin is injected from the opening of the connected tube on the side opposite to the side where the rubber plug is provided, and the tube inner space is filled with the epoxy resin. Thereafter, an end of the prepared bundle of the composite hollow fiber membranes is thermally sealed so that the epoxy resin does not enter the hollow portion, the bundle is inserted into the tube filled with the epoxy resin until the tip of the end comes into contact with the rubber plug, and the epoxy resin is cured as it is. Next, the region on the rubber plug side of the cured epoxy resin portion is cut together with the tube to open the hollow portion. The same operation is performed for the other end to produce a crossflow module in which hollow portions at both ends of the composite hollow fiber membranes are open.

The produced crossflow module 6 is connected to an internal pressure type separation processing line shown in FIG. 1, and a fluid liquid is caused to continuously pass through the crossflow module 6 with a liquid feeding circulation pump 2. As the fluid liquid, NMP or thinner is used. In the module, the pressure of a primary pressure gauge 3 and the pressure of a secondary pressure gauge 4 are adjusted with a regulator 5 such that the arithmetic average value of the pressure of the primary pressure gauge 3 and the pressure of the secondary pressure gauge 4 is 90% with respect to the burst pressure of the composite hollow fiber membrane. The fluid liquid that has passed through the pores of the composite hollow fiber membrane among the fluid liquid passing the inside of the module is recovered as a permeate separated from the fluid liquid, and the remaining fluid is caused to circulate again to the separation processing line. The permeate flowing out of the crossflow module 6 from 2 hours to 4 hours after the start of circulation is collected with a tray 7, and the NMP permeation amount or the thinner permeation amount (L/(m²·h)) is calculated according to the following calculation formula.

NMP permeation amount=volume (L) of NMP permeated to outside of composite hollow fiber membrane/[inner diameter (m) of composite hollow fiber membrane×3.14×effective filtration length (m) of composite hollow fiber membrane×20 (fibers)×time (h)]

Thinner permeation amount=volume (L) of thinner permeated to outside of composite hollow fiber membrane/[inner diameter (m) of composite hollow fiber membrane×3.14×effective filtration length (m) of composite hollow fiber membrane×20 (fibers)×time (h)]

The effective filtration length of the composite hollow fiber membrane is the length of a portion of the outer surface of the composite hollow fiber membrane that is not coated with the epoxy resin in the crossflow module.

The burst pressure of the composite hollow fiber membrane of the present invention is not particularly limited, and can be adjusted to a desired value by appropriately adjusting the thickness of the dense layer, the thickness of the support layer, the pore diameter of pores of the support layer, and the like, but is preferably 10 bar or more, more preferably 15 bar or more, still more preferably 20 bar or more, and further still more preferably 25 bar or more from the viewpoint of increasing the operating pressure at the time of membrane filtration to increase the amount of liquid permeation. The upper limit value of the burst pressure of the composite hollow fiber membrane is usually 40 bar or less, and preferably 35 bar or less. Specifically, the burst pressure of the composite hollow fiber membrane of the present invention is preferably 10 to 40 bar, more preferably 15 to 35 bar, still more preferably 20 to 35 bar, and further still more preferably 25 to 35 bar. In the present invention, the burst pressure of the composite hollow fiber membrane of the present invention is a pressure (bar) at which the composite hollow fiber membrane in a module produced using the composite hollow fiber membrane ruptures with application of water pressure.

Specifically, the burst pressure of the composite hollow fiber membrane is measured by the following method. First, the module 8 illustrated in a of FIG. 2 is produced. Specifically, first, a bundle in which 10 composite hollow fiber membranes 8a cut into a length of 30 cm are put together is prepared. Next, a nylon hard tube 8b having an outer diameter of 8 mm, an inner diameter of 6 mm, and a length of 50 mm is prepared, and a rubber plug having a length of about 20 mm is inserted from one end opening of the tube to plug the one end opening. Next, a two-liquid mixing type epoxy resin is injected from the opening of the tube on the side opposite to the side where the rubber plug is provided, and the tube inner space is filled with the epoxy resin. Thereafter, the prepared bundle of the composite hollow fiber membranes is bent into a substantially U shape, both ends of the composite hollow fiber membranes are thermally sealed so that the epoxy resin does not enter the hollow portion, the bundle is inserted into the tube filled with the epoxy resin until the tip of the end comes into contact with the rubber plug, and the epoxy resin is cured as it is. Then, the region on the rubber plug side of the cured epoxy resin portion is cut together with the tube. Whereby the module 8 in which hollow portions at both ends of the composite hollow fiber membranes are open is produced.

Next, the module 8 is set in the apparatus illustrated in b of FIG. 2, water pressure is applied to the module 8 with a hand pump 9. The pressure (bar) at which the module ruptures is defined as the burst pressure.

The composite hollow fiber membrane of the present invention is preferably an ultrafiltration membrane or a nanofiltration membrane, more preferably a nanofiltration membrane, that is, having a molecular weight cut-off of 200 to 1000. However, because the method for measuring the molecular weight cut-off is complicated, it is preferable to use the rejection rate of vitamin B₁₂ (molecular weight: 1355.38) as a simple method for specifying the classification of the filtration membrane. It has been confirmed in the tests conducted by the inventors of the present invention that the composite hollow fiber membrane of the present invention having a molecular weight cut-off of 1000 has a rejection rate of vitamin B₁₂ of 89%. Thus, when the rejection rate of vitamin B₁₂ is 90% or more, the composite hollow fiber membrane of the present invention can be determined to be a nanofiltration membrane. In the composite hollow fiber membrane of the present invention, the rejection rate of vitamin B₁₂ is preferably 95% or more, more preferably 97% or more, and still more preferably 99% or more.

As one embodiment of the composite hollow fiber membrane of the present invention, the rejection rate of vitamin B₁₂ when a solution in which the solvent is NMP or a thinner and the solute is vitamin B₁₂ is filtered is preferably 90% or more, more preferably 95% or more, still more preferably 97% or more, and further still more preferably 99% or more. The rejection rate of vitamin B₁₂ can be adjusted to a desired value by appropriately adjusting the type of polyamide resin as a material for forming the polyamide hollow fiber membrane, the molecular weight cut-off of the polyamide hollow fiber membrane, the thickness of the dense layer, the type of silicone as a material for forming the silicone layer, the thickness of the silicone layer, and the like.

The rejection rate of vitamin B₁₂ is a value measured through internal pressure filtration, and is a value measured in the same measurement procedure as in the measurement of the NMP permeation amount and the thinner permeation amount. The absorbance of the obtained permeate and fluid liquid at a wavelength of 550 nm is measured using an absorptiometer, and the rejection rate of vitamin B₁₂ is calculated from the following formula. As the fluid liquid, an NMP solution or a thinner solution of vitamin B₁₂ (500 ppm) is used.

Rejection rate of vitamin B₁₂=100−(absorbance of permeate/absorbance of fluid liquid)×100

### [Organic Solvent Resistance]

Since the composite hollow fiber membrane of the present invention is mainly formed of a polyamide resin and silicone, the composite hollow fiber membrane has characteristics (organic solvent resistance) of suppressing changes in strength and elongation and stably holding the membrane structure even when the composite hollow fiber membrane is brought into contact with various types of organic solvents. More specifically, the composite hollow fiber membrane of the present invention has resistance to organic solvents such as alcohols, aprotic polar solvents, hydrocarbons, higher fatty acids, ketones, esters, and ethers. Specific examples of the type of the organic solvent include the following.

Alcohols: Primary alcohols such as methanol, ethanol, n-propanol, n-butanol, and benzyl alcohol; secondary alcohols such as isopropyl alcohol and isobutanol; tertiary alcohols such as tertiary butyl alcohol; polyhydric alcohols such as ethylene glycol, diethylene glycol, triethylene glycol, tetraethylene glycol, propylene glycol, 1,3-butanediol, and glycerol.

Ketones: Acetone, methyl ethyl ketone, cyclohexanone, diisopropyl ketone, and the like.

Ethers: 3-Methoxybutanol, 3-methoxybutyl acetate, tetrahydrofuran, diethyl ether, diisopropyl ether, 1,4-dioxane, ethylene glycol monomethyl ether, diethylene glycol monomethyl ether, diethylene glycol monoethyl ether, diethylene glycol monobutyl ether, dipropylene glycol monomethyl ether, dipropylene glycol monomethyl ether acetate, propylene glycol monomethyl ether, propylene glycol monomethyl ether acetate, and the like.

Aprotic polar solvent: N,N-dimethylformamide, N,N-dimethylacetamide, dimethyl sulfoxide, N-methyl-2-pyrrolidone, sulfolane, and the like.

Esters: Ethyl acetate, isobutyl acetate, ethyl lactate, dimethyl phthalate, diethyl phthalate, ethylene carbonate, propylene carbonate, and the like.

Hydrocarbons: Petroleum ether, pentane, hexane, heptane, benzene, toluene, xylene, liquid paraffin, gasoline, and mineral oil.

Higher fatty acid: A fatty acid having 4 or more (preferably 4 to 30) carbon atoms other than a carboxy group, such as oleic acid, linoleic acid, or linolenic acid.

### Application

The composite hollow fiber membrane of the present invention is suitably used, for example, as an ultrafiltration membrane or a nanofiltration membrane in the fields of semiconductor industry, chemical industry, food industry, pharmaceutical industry, medical product industry, and the like. In particular, the composite hollow fiber membrane of the present invention is suitably used for filtration of a liquid to be treated containing an organic solvent and a solute, which are used in electronic industries such as semiconductor and liquid crystal panel manufacturing.

In addition, because the composite hollow fiber membrane of the present invention has resistance to various organic solvents, the composite hollow fiber membrane is suitably used in a membrane separation process in which a liquid to be treated containing an organic solvent and a solute is a treatment target.

### 3. Method for Manufacturing Composite Hollow Fiber Membrane

The method for manufacturing the composite hollow fiber membrane of the present invention is not particularly limited as long as a composite hollow fiber membrane having the structure described above can be obtained, and preferable examples thereof include a manufacturing method including the following first to fourth steps.

First Step: A membrane-forming dope solution is prepared by dissolving a polyamide resin at a concentration of 20 wt % or more at a temperature of 100 °C or higher in an organic solvent having a boiling point of 150 °C or higher and incompatible with the polyamide resin at a temperature of lower than 100 °C.

Second Step: A step of extruding the membrane-forming dope solution into a coagulation bath at 100 °C or lower in a predetermined shape to coagulate the polyamide resin into a membrane shape, wherein in the step, a coagulation liquid having compatibility with the organic solvent used in the membrane-forming dope solution and low affinity for the polyamide resin is brought into contact with at least one surface of the membrane-forming dope solution extruded in a predetermined shape to form a polyamide hollow fiber membrane having a dense layer on at least one surface.

Third Step: The solvent of the membrane-forming dope solution and the coagulation liquid are removed from the polyamide hollow fiber membrane formed in the second step.

Fourth Step: A silicone layer is formed on a surface of at least one dense layer of the polyamide hollow fiber membrane obtained by performing the third step.

### [Formation of Polyamide Hollow Fiber Membrane]

Hereinafter, the first to third steps for forming the polyamide hollow fiber membrane will be described in detail for each step.

### First Step

In the first step, a membrane-forming dope solution is prepared by dissolving a polyamide resin at a concentration of 20 wt % or more at a temperature of 100 °C or higher in an organic solvent having a boiling point of 150 °C or higher and incompatible with the polyamide resin at a temperature of lower than 100 °C.

Examples of the organic solvent having a boiling point of 150 °C or higher and incompatible with the polyamide resin at a temperature of lower than 100 °C include aprotic polar solvents, glycerol ethers, polyhydric alcohols, organic acids and organic acid esters, and higher alcohols. Specific examples of the aprotic polar solvent include sulfolane, dimethylsulfone, dimethylsulfoxide, γ-butyrolactone, δ-valerolactone, ε-caprolactone, N,N-dimethylformamide, N,N-dimethylacetamide, N-methyl-2-pyrrolidone, ethylene carbonate, and propylene carbonate. Specific examples of the glycerol ethers include diethylene glycol dimethyl ether, diethylene glycol diethyl ether, triethylene glycol dimethyl ether, diethylene glycol dibutyl ether, and tetraethylene glycol dimethyl ether. Specific examples of the polyhydric alcohols include glycerol, ethylene glycol, diethylene glycol, triethylene glycol, propylene glycol, hexylene glycol, 1,3-butanediol, and polyethylene glycol (molecular weight: 100 to 10,000). Specific examples of the organic acids and the organic acid esters include dimethyl phthalate, diethyl phthalate, diisopropyl phthalate, dibutyl phthalate, butyl benzyl phthalate, methyl salicylate, oleic acid, palmitic acid, stearic acid, and lauric acid. Among these organic solvents, an aprotic polar solvent and a polyhydric alcohol are preferable from the viewpoint of obtaining a polyamide hollow fiber membrane having higher strength; more preferably, sulfolane, dimethylsulfone, γ-butyrolactone, δ-valerolactone, ε-caprolactone, propylene glycol, hexylene glycol, 1,3-butanediol, polyethylene glycol (molecular weight: 100 to 600); still more preferably, sulfolane, dimethylsulfone, γ-butyrolactone, δ-valerolactone, ε-caprolactone; and further still more preferably, dimethylsulfone is exemplified. These organic solvents may be used singly, or may be used in combination of two or more thereof. A sufficient effect can be obtained with one of these organic solvents used singly, but when two or more of these organic solvents are used in combination, a more effective polyamide hollow fiber membrane can be produced because of the difference in the order and structure of phase separation.

The concentration of the polyamide resin in the membrane-forming dope solution may be 20 wt % or more, and is preferably 23 to 50 wt %, more preferably 25 to 38 wt %, still more preferably 28 to 35 wt %. When the concentration of the polyamide resin in the membrane-forming dope solution satisfies the above range, a support layer having a porosity of 60 to 80% can be obtained, the polyamide hollow fiber membrane can have excellent pressure resistance, and as a result, the composite hollow fiber membrane of the present invention can have excellent pressure resistance and liquid permeability of the organic solvent.

When the polyamide resin is dissolved in the organic solvent in the first step, it is necessary to set the temperature of the solvent to 100 °C or higher. Specifically, it is desirable to dissolve the polyamide resin at a temperature higher by 10 to 50 °C, preferably higher by 20 to 40 °C than the phase separation temperature of the membrane-forming dope solution to be prepared. The phase separation temperature of the membrane-forming dope solution refers to a temperature at which solid-liquid phase separation occurs through liquid-liquid phase separation or crystal precipitation when a mixture of the polyamide resin and the organic solvent mixed at a sufficiently high temperature is gradually cooled. The phase separation temperature can be measured by using a microscope or the like equipped with a hot stage.

In the first step, the temperature condition for dissolving the polyamide resin in the organic solvent may be appropriately set in a temperature range of 100 °C or higher according to the above-described index depending on the type of the polyamide resin and the type of the organic solvent to be used, and is preferably 120 to 250 °C, more preferably 140 to 220 °C, still more preferably 160 to 200 °C.

To the membrane-forming dope solution, a filler, a thickener, an antioxidant, a surface modifier, a lubricant, and a surfactant may be added as necessary for controlling the pore size and improving the membrane performance of the polyamide hollow fiber membrane.

The membrane-forming dope solution prepared in the first step is subjected to the second step at the same temperature (that is, in a state of 100 °C or higher).

### Second Step

The second step is a step of extruding the membrane-forming dope solution prepared in the first step into a coagulation bath at 100 °C or lower in a predetermined shape to coagulate the polyamide resin into a membrane shape, wherein in the step, a coagulation liquid having compatibility with the organic solvent used in the membrane-forming dope solution and low affinity for the polyamide resin (hereinafter, may be referred to a “coagulation liquid for dense layer formation”) is brought into contact with at least one surface of the membrane-forming dope solution extruded in a predetermined shape to form a polyamide hollow fiber membrane having a dense layer on at least one surface.

In the second step, the membrane-forming dope solution extruded into a coagulation bath in a predetermined shape forms a dense layer on the surface in contact with the coagulation liquid for dense layer formation. In the vicinity of the surface where the membrane-forming dope solution is in contact with the coagulation liquid for dense layer formation, non-solvent phase separation through solvent exchange proceeds predominantly rather than thermally induced phase separation through cooling, and a denser structure than the structure formed by the conventional TIPS method is formed on the surface. As a result, a polyamide hollow fiber membrane having the molecular weight cut-off described above is obtained.

When a dense layer is formed only on one surface of the polyamide hollow fiber membrane, in the second step, the coagulation liquid for dense layer formation may be brought into contact with one surface of the membrane-forming dope solution extruded in a predetermined shape, and a coagulation liquid having compatibility with the organic solvent used for the membrane-forming dope solution and high affinity for a polyamide resin (hereinafter, may be referred to as “coagulation liquid for support layer formation”) may be brought into contact with the other surface. When the dense layer is formed on both surfaces of the polyamide hollow fiber membrane, in the second step, the coagulation liquid for dense layer formation may be brought into contact with both surfaces of the membrane-forming dope solution extruded in a predetermined shape.

Specifically, the coagulation liquid for dense layer formation is a solvent which is compatible with the organic solvent used in the membrane-forming dope solution at a temperature of 25 °C or lower, but does not dissolve the polyamide resin at a temperature of the boiling point or lower or 200 °C or lower. Specific examples of the coagulation liquid for dense layer formation include aqueous solvents such as water and aqueous solutions having a water content of 80 wt % or more; monohydric alcohols such as 1-propanol, 2-propanol, and isobutanol; glycol ethers such as polyethylene glycol having an average molecular weight of 300 or more, polypropylene glycol having an average molecular weight of 400 or more, diethylene glycol diethyl ether, triethylene glycol monomethyl ether, and propylene glycol monoethyl ether; glycol acetates such as triacetin and propylene glycol monoethyl ether acetate. Among these, polyethylene glycol having an average molecular weight of 300 to 600, triacetin, and triethylene glycol monomethyl ether are preferable; polyethylene glycol 300, polyethylene glycol 400, and polyethylene glycol 600 are more preferable; and polyethylene glycol 300 and polyethylene glycol 400 are still more preferable. These solvents may be used singly, or may be used in combination of two or more thereof. In the present invention, the average molecular weights of polyethylene glycol and polypropylene glycol are number average molecular weights calculated based on a hydroxyl value measured in accordance with JIS K 1557-6:2009 “Plastic-polyurethane raw material polyol test method-Part 6: Method for determining hydroxyl value by near infrared (NIR) spectroscopy”.

The coagulation liquid for dense layer formation may contain a solvent (solvent which is compatible with the organic solvent used in the membrane-forming dope solution at a temperature of 25 °C or lower and dissolves the polyamide resin at a temperature of the boiling point or lower) used in the coagulation liquid for support layer formation such as glycerol as long as the dense layer can be formed. When the coagulation liquid for dense layer formation contains the solvent (preferably, at least one selected from the group consisting of glycerol, diglycerol, 1,3-butanediol, 1,4-butanediol, diethylene glycol, tetraethylene glycol, and polyethylene glycol 200) used in the coagulation liquid for support layer formation, the content of the solvent is preferably 5 to 38 wt %, more preferably 10 to 35 wt %, still more preferably 15 to 32 wt %, and further still more preferably 15 to 30 wt % from the viewpoint of forming a dense layer having a suitable thickness and obtaining a polyamide hollow fiber membrane having the molecular weight cut-off described above.

The coagulation liquid for support layer formation is not limited as long as it is a solvent which is compatible with the organic solvent used in the membrane-forming dope solution at a temperature of 25 °C or lower and dissolves the polyamide resin at a temperature of the boiling point or lower. Specific examples of the coagulation liquid for support layer formation include glycerol, ethylene glycol, diethylene glycol, triethylene glycol, tetraethylene glycol, polyethylene glycol 200, propylene glycol, 1,3-butanediol, 1,4-butanediol, sulfolane, N-methyl-2-pyrrolidone, γ-butyrolactone, δ-valerolactone, and an aqueous solution containing 20 wt % or more of these. Among these, from the viewpoint of obtaining a support layer having the porosity described above, at least one selected from the group consisting of 1,4-butanediol, 1,3-butanediol, glycerol, propylene glycol, diethylene glycol, tetraethylene glycol, and polyethylene glycol 200, and an aqueous solution containing at least one of these at a proportion of 25 to 75 wt % is preferable; at least one selected from the group consisting of 1,4-butanediol, glycerol, propylene glycol, diethylene glycol, and tetraethylene glycol, and an aqueous solution containing at least one of these at a proportion of 40 to 80 wt % (preferably 40 to 60 wt %) is more preferable.

To form the polyamide hollow fiber membrane, the second step may be performed by using a double tubular nozzle for manufacturing a hollow fiber having a double tube structure, discharging the membrane-forming dope solution from an outer annular nozzle and discharging a coagulation liquid for inside from an inner nozzle, and immersing them in a coagulation bath. At this time, the coagulation liquid for dense layer formation may be used for at least one of the coagulation liquid for inside and the coagulation bath. When the coagulation liquid for dense layer formation is used for both the coagulation liquid for inside and the coagulation bath, a polyamide hollow fiber membrane is obtained in which a dense layer is formed on both the lumen-side surface and the outer surface, and the inside is a support layer. When the coagulation liquid for dense layer formation is used for the coagulation liquid for inside, and the coagulation liquid for support layer formation is used for the coagulation bath, a polyamide hollow fiber membrane is obtained in which a dense layer is formed on the lumen-side surface, and the inside and the outer surface are support layers. When the coagulation liquid for support layer formation is used for the coagulation liquid for inside, and the coagulation liquid for dense layer formation is used for the coagulation bath, a polyamide hollow fiber membrane is obtained in which a dense layer is formed on the outer surface, and the lumen-side surface and the inside are support layers. Since the coagulation liquid for inside used for forming the polyamide hollow fiber membrane passes through the double annular nozzle, it is preferable that the coagulation liquid for inside does not contain water having a boiling point equal to or lower than the temperature of the double annular nozzle.

As the double tubular nozzle for manufacturing a hollow fiber, a spinneret having a double tubular structure that is used when a core-sheath type composite fiber is produced in melt spinning can be used. The diameter of the outer annular nozzle and the diameter of the inner nozzle of the double tubular nozzle for manufacturing a hollow fiber may be appropriately set according to the inner diameter and the outer diameter of the polyamide hollow fiber membrane.

The flow rate at the time of discharging the membrane-forming dope solution from the outer annular nozzle of the double tubular nozzle for manufacturing a hollow fiber is not particularly limited because it depends on the slit width thereof, but is, for example, 2 to 30 g/min, preferably 3 to 20 g/min, still more preferably 5 to 15 g/min. The flow rate of the coagulation liquid for inside is appropriately set in consideration of the diameter of the inner nozzle of the double tubular nozzle for manufacturing a hollow fiber, the type of the internal liquid to be used, the flow rate of the membrane-forming dope solution, and the like, and is 0.1 to 2 times, preferably 0.2 to 1 times, still more preferably 0.4 to 0.7 times the flow rate of the membrane-forming dope solution.

In the second step, the temperature of the coagulation bath may be 100 °C or lower, and is preferably −20 to 100 °C, more preferably 0 to 60 °C, still more preferably 2 to 20 °C, and particularly preferably 2 to 10 °C. The suitable temperature of the coagulation bath may vary depending on the organic solvent used for the membrane-forming dope solution, the composition of the coagulation liquid, and the like, but in general, there is a tendency that thermally induced phase separation preferentially proceeds by setting the temperature to a lower temperature, and non-solvent phase separation preferentially proceeds by setting the temperature to a higher temperature. That is, in the case of manufacturing a polyamide hollow fiber membrane having a dense layer formed on the lumen-side surface, it is preferable to set the coagulation bath to a low temperature to increase the pore size of the dense layer on the lumen-side surface, and it is preferable to set the coagulation bath to a high temperature to make the dense layer on the lumen-side surface denser and to coarsen the internal structure. The temperature of the coagulation liquid for inside may be about the set temperature of the double tubular nozzle, and is, for example, 120 to 250 °C, preferably 160 to 230 °C, more preferably 180 to 220 °C.

By performing the second step like this, the membrane-forming dope solution is coagulated in the coagulation bath, and a polyamide hollow fiber membrane having a dense layer formed on at least one surface is formed.

### Third Step

In the third step, the solvent of the membrane-forming dope solution and the coagulation liquid are removed from the polyamide hollow fiber membrane formed in the second step.

The method for removing the solvent of the membrane-forming dope solution and the coagulation liquid from the polyamide hollow fiber membrane is not particularly limited, but a method for immersing the polyamide hollow fiber membrane formed in the second step in an extraction solvent to extract and remove the solvent of the membrane-forming dope solution and the coagulation liquid is preferable.

As the extraction solvent used for extraction and removal, an extraction solvent that is inexpensive and has a low boiling point and can be easily separated after extraction because of a difference in boiling point or the like is preferable. Examples thereof include water, glycerol, methanol, ethanol, isopropanol, acetone, diethyl ether, hexane, petroleum ether, and toluene. Among these, water, methanol, ethanol, isopropanol, and acetone are preferable; and water, methanol, and isopropanol are more preferable. In particular, in the case of extracting a solvent of a membrane-forming dope solution and a coagulation liquid that are dissolved in water, solvent extraction can be performed at the same time by winding is performed while performing showering with water, which is efficient. When an organic solvent insoluble in water, such as phthalic acid ester or fatty acid, is extracted, isopropyl alcohol, petroleum ether, or the like can be suitably used.

When extraction and removal of the solvent of the membrane-forming dope solution and the coagulation liquid is performed by immersing the polyamide hollow fiber membrane in an extraction solvent, the time for immersing the polyamide hollow fiber membrane in the extraction solvent is not particularly limited, but is, for example, 0.2 hours to 2 months, preferably 0.5 hours to 1 month, still more preferably 2 hours to 10 days. To effectively extract and remove the coagulation liquid and the like remaining in the polyamide hollow fiber membrane, the extraction solvent may be replaced or stirred.

By performing the third step like this, a polyamide hollow fiber membrane having a dense layer formed on at least one surface is formed from which the solvent of the membrane-forming dope solution and the coagulation liquid are removed.

After the third step, the extraction solvent in the polyamide hollow fiber membrane is preferably removed by drying. The extraction solvent can be dried and removed by a known drying treatment such as natural drying, hot air drying, reduced-pressure drying, vacuum drying, or the like.

To increase the strength of the polyamide hollow fiber membrane and provide excellent pressure resistance, the polyamide hollow fiber membrane may be stretched in a uniaxial direction (longitudinal direction) simultaneously with or after drying.

To stretch the polyamide hollow fiber membrane in a uniaxial direction simultaneously with drying, the polyamide hollow fiber membrane may be dried while a tension for stretching is applied to the polyamide hollow fiber membrane. The temperature condition at the time of stretching the membrane in a uniaxial direction simultaneously with drying is not particularly limited as long as both drying and stretching are possible, but it is, for example, 40 °C or higher, preferably 40 to 160 °C, more preferably 50 °C to 140 °C, and still more preferably 120 to 140 °C.

The temperature condition at the time of stretching the membrane in a uniaxial direction after drying is not particularly limited as long as the extraction solvent attached to the membrane can be volatilized, but it is, for example, 40 °C or higher, preferably 40 to 160 °C, more preferably 50 °C to 140 °C, and still more preferably 120 to 140 °C. When the polyamide hollow fiber membrane is stretched in a uniaxial direction after drying, the temperature condition at the time of stretching is not particularly limited, and it may be −10 to 140 °C, preferably 0 to 120 °C. However, from the viewpoint of further improving the liquid permeability, the temperature is preferably equal to or higher than the glass transition point (more preferably 50 to 120 °C), still more preferably 60 to 100 °C) of the polyamide resin used.

The uniaxial stretching may be performed by a known method, and may be continuously performed by winding from a low-speed roll to a high-speed roll, for example. Alternatively, both ends of the polyamide hollow fiber membrane cut into a certain length may be gripped and stretched using a tensile tester or the like, or manual stretching may be used.

The draw ratio is, for example, 1.2 to 5 times, preferably 1.2 to 3 times. From the viewpoint of increasing the strength of the polyamide hollow fiber membrane and providing excellent pressure resistance, the draw ratio is preferably 1.2 to 2.4 times, more preferably 1.2 to 2.0 times.

### [Formation of Silicone Layer]

Hereinafter, the fourth step for forming a silicone layer on a surface of at least one dense layer of the polyamide hollow fiber membrane obtained by performing the third step will be described in detail.

The method for forming the silicone layer is not particularly limited as long as a silicone layer having the above-described structure and properties can be obtained, and examples of the suitable method include the forming method described below.

Examples of the method for forming a silicone layer on a surface of the dense layer on the lumen-side surface of the polyamide hollow fiber membrane include a method of injecting a silicone coating liquid into the hollow portion of the polyamide hollow fiber membrane to form a silicone coating membrane on a surface of the dense layer and curing the silicone coating membrane to form a silicone layer.

The silicone coating liquid is a liquid composition containing a precursor (uncured product) of silicone (for example, silicone rubber) described in the column of “Silicone Layer” in “2. Composite Hollow Fiber Membrane”. Hereinafter, as a representative example, a case where the silicone as a material for forming the silicone layer is a two-liquid curable silicone rubber will be described.

The silicone coating liquid contains at least a precursor of a two-component curable silicone rubber (a polyorganosiloxane as a base polymer and a crosslinking agent), and can be prepared, for example, by mixing a first liquid (main agent) containing a polyorganosiloxane and a curing catalyst with a second liquid (curing agent) containing a crosslinking agent. Examples of commercially available products of the two-component curable silicone rubber kit in which a main agent and a curing agent are combined include SYLGARD (trademark) 184 and 527, DOWSIL (trademark) EG-3100 and CY52-276 manufactured by Dow Toray Co., Ltd., YE5822 and TSE3032, 3033 and 3070 manufactured by Momentive Performance Materials Japan LLC, and KE-109E, KE-106F, KE-1012, KE-1051 and FE-77 manufactured by Shin-Etsu Chemical Co., Ltd.

The silicone coating liquid preferably contains a diluting solvent from the viewpoint of forming a thin and uniform silicone layer on a surface of the dense layer, the viewpoint of facilitating control of the addition reaction, and the viewpoint of workability. The diluting solvent may be added to either one or both of the main agent and the curing agent before mixing the main agent and the curing agent, or may be added to a mixture obtained by mixing the main agent and the curing agent.

The diluting solvent is not particularly limited as long as it is a solvent that dissolves the polyorganosiloxane and the crosslinking agent, and examples thereof include linear alkanes such as hexane and pentane; aromatic hydrocarbons such as toluene and xylene; ketones such as acetone and methyl ethyl ketone; esters such as ethyl acetate; and cyclic ethers such as tetrahydrofuran.

The blending amount of the diluting solvent needs to be appropriately adjusted depending on the viscosity of the polyorganosiloxane, and is preferably an amount at which the concentration of the polyorganosiloxane in the silicone coating liquid is 2 to 40 wt %, more preferably 5 to 30 wt %, and still more preferably 10 to 20 wt % from the viewpoint of holding the silicone coating membrane at a desired thickness on a surface of the dense layer, the viewpoint of suppressing generation of defects in the silicone layer due to excessive thinning of the silicone layer, the viewpoint of suppressing thickness unevenness of the silicone layer, and the viewpoint of workability.

In the silicone coating liquid, the blending proportion of the crosslinking agent needs to be appropriately adjusted according to the type of the polyorganosiloxane and the crosslinking agent, and is usually 1 to 30 parts by weight, preferably 3 to 25 parts by weight, and more preferably 5 to 20 parts by weight in terms of solid content with respect to 100 parts by weight of the polyorganosiloxane.

The method for injecting the silicone coating liquid into the hollow portion of the polyamide hollow fiber membrane is not particularly limited as long as the silicone coating membrane can be formed at a desired thickness on a surface of the dense layer, but the method is preferably a method of forming a module using the polyamide hollow fiber membrane and injecting the silicone coating liquid into the hollow portion of the polyamide hollow fiber membrane of the module. Specifically, the injection method is performed according to the procedure shown below. First, a bundle is prepared in which a desired number of polyamide hollow fiber membranes having a desired length are put together. Next, a hard tube is prepared, a rubber plug or the like having an appropriate length is inserted into one end opening of the tube, and the one end opening is plugged. Next, a two-liquid mixing type thermosetting resin is injected from the opening at the end of the tube on the side opposite to the side where the plug is provided, and the tube inner space is filled with the resin. Thereafter, one end of the prepared bundle of the polyamide hollow fiber membranes is thermally sealed, and the bundle is inserted into the tube filled with the thermosetting resin until the tip of the end comes into contact with the plug, and the thermosetting resin is cured as it is. Next, the region on the plug side of the cured resin portion is cut together with the tube to open the hollow portion of the polyamide hollow fiber membrane. Thereafter, an appropriate jig is attached to the tube on the opening side, and the silicone coating liquid is injected.

The injection method is not particularly limited, and examples thereof include an injection method using a syringe, a pumping method using a pressurized gas, and an injection method using a pump such as a peristaltic pump, a plunger pump, a diaphragm pump, or a gear pump.

The speed at which the silicone coating liquid is injected is not particularly limited, but is, for example, about 0.04 to 2.5 m/sec as a linear velocity, and is preferably 0.1 to 1.0 m/sec and more preferably 0.1 to 0.5 m/sec from the viewpoint of suppressing occurrence of defects in the silicone layer, the viewpoint of suppressing thickness unevenness of the silicone layer, and the viewpoint of manufacturing efficiency.

To form a silicone coating membrane having a uniform thickness on a surface of the dense layer, it is preferable to blow a gas into the hollow portion of the polyamide hollow fiber membrane after injecting the silicone coating liquid. The gas used for blowing is not particularly limited, but is preferably dry air or nitrogen from the viewpoint of preventing reaction with the silicone coating liquid and the viewpoint of safety.

The blow speed is not particularly limited, but is, for example, about 1 to 50 m/sec as a linear velocity, and is preferably 2.5 to 20 m/sec and more preferably 5 to 10 m/sec from the viewpoint of suppressing occurrence of defects in the silicone layer, the viewpoint of suppressing thickness unevenness of the silicone layer, and the viewpoint of manufacturing efficiency.

To promote curing (addition reaction) of the silicone coating membrane formed on a surface of the dense layer, it is preferable to perform a heat treatment on the silicone coating membrane. The heating temperature is not particularly limited, but is preferably 40 to 160 °C, more preferably 60 to 140 °C, and still more preferably 80 to 120 °C from the viewpoint of further promoting curing (addition reaction) and suppressing deterioration of physical properties of the polyamide hollow fiber membrane due to heat. The heating time is not particularly limited, but is preferably 10 minutes to 24 hours, more preferably 15 minutes to 16 hours, still more preferably 30 minutes to 8 hours, and further still more preferably 1 to 5 hours from the above-described viewpoints.

The tube portion used at the time of injection of the silicone coating liquid is removed by cutting at an appropriate time, for example, before or after the heat treatment on the silicone coating membrane.

Examples of the method for forming a silicone layer on a surface of the dense layer on the outer surface of the polyamide hollow fiber membrane include a method of immersing the polyamide hollow fiber membrane into a bath of the silicone coating liquid or applying the silicone coating liquid onto the outer surface of the polyamide hollow fiber membrane to form a silicone coating membrane on a surface of the dense layer and curing the silicone coating membrane to form a silicone layer. To form a silicone coating membrane having a uniform thickness on the surface of the dense layer, the gas described above may be blown onto the outer surface of the polyamide hollow fiber membrane. To promote curing (addition reaction) of the silicone coating membrane formed on a surface of the dense layer, a heat treatment may be performed on the silicone coating membrane under the conditions described above.

Examples of the method for forming a silicone layer on each of the surfaces of the dense layer on the lumen-side surface and the outer surface of the polyamide hollow fiber membrane include a method in which the method of forming a silicone layer on the surface of the dense layer on the lumen-side surface of the polyamide hollow fiber membrane and the method of forming a silicone layer on the surface of the dense layer on the outer surface of the polyamide hollow fiber membrane are performed in any order or in combination.

By performing the fourth step like this, the composite hollow fiber membrane of the present invention having a silicone layer on the surface of at least one dense layer of the polyamide hollow fiber membrane is obtained.

### 4. Hollow Fiber Membrane Module

The composite hollow fiber membrane of the present invention is housed in a module case provided with an inlet for liquid to be treated, an outlet for permeate, and the like, and is used as a hollow fiber membrane module.

Specifically, the hollow fiber membrane module has a structure in which the composite hollow fiber membrane of the present invention is bundled, housed in a module case, and one or both ends of the composite hollow fiber membrane are sealed and fixed with a potting agent. The hollow fiber membrane module is provided with an opening connected to a flow path passing through the outer wall surface side of the composite hollow fiber membrane and an opening connected to the hollow portion of the composite hollow fiber membrane as an inlet for liquid to be treated or an outlet for filtrate.

The shape of the hollow fiber membrane module is not particularly limited, and the module may be a deadend-type module or a crossflow-type module. Specific examples thereof include a deadend-type module in which the hollow fiber membrane bundle is bent into a U-shape and filled, and an end of the hollow fiber membrane bundle is sealed and then cut to be opened; a deadend-type module in which a hollow opening at one end of the hollow fiber membrane bundle closed by thermal sealing or the like is filled straight, and an end of the hollow fiber membrane bundle on the opening side is cut after sealing to open the hollow fiber membrane bundle; deadend-type module in which the hollow fiber membrane bundle is filled straight, both ends of the hollow fiber membrane bundle are sealed, and only one end is cut to expose opening; and a crossflow-type module in which the hollow fiber membrane bundle is filled straight, both ends of the hollow fiber membrane bundle are sealed, sealing portions at both ends of the hollow fiber membrane bundle are cut, and two flow paths are formed on a side surface of a filter case.

The filling rate of the composite hollow fiber membrane inserted into the module case is not particularly limited, but for example, the volume of the composite hollow fiber membrane including the volume of the hollow portion with respect to the volume inside the module case is preferably 15 to 75 vol %, more preferably 25 to 65 vol %, and still more preferably 35 to 55 vol %. By satisfying such a filling rate, the filling operation of the composite hollow fiber membrane into the module case can be facilitated while securing a sufficient filtration area, and the potting agent can easily flow between the composite hollow fiber membranes.

The potting agent to be used for the manufacture of the hollow fiber membrane module is not particularly limited, but when the hollow fiber membrane module is used for the treatment of an organic solvent, it is desirable to have organic solvent resistance, and examples of such a potting agent include polyamide, silicone resin, epoxy resin, melamine resin, polyethylene, polypropylene, phenol resin, polyimide, and polyurea resin. Among these potting agents, those having small shrinkage and swelling when cured and having a hardness that is not too hard are preferable, and suitable examples thereof include polyamide, silicone resin, epoxy resin, and polyethylene. These potting agents may be used singly, or may be used in combination of two or more thereof.

The material of the module case used for the hollow fiber membrane module is not particularly limited, and examples thereof include polyamide, polyester, polyethylene, polypropylene, polyvinylidene fluoride, polytetrafluoroethylene, polyvinyl chloride, polysulfone, polyethersulfone, polycarbonate, polyarylate, and polyphenylene sulfide. Among these, polyamide, polyethylene, polypropylene, polytetrafluoroethylene, polycarbonate, polysulfone, and polyethersulfone are preferable, and polyamide, polyethylene, polypropylene, and polytetrafluoroethylene are more preferable.

The hollow fiber membrane module using the composite hollow fiber membrane of the present invention is used in ultrafiltration or nanofiltration applications for removal of foreign substances in a solvent, concentration of useful components in a solvent, recovery of a solvent, and the like in fields such as semiconductor industry, chemical industry, food industry, pharmaceutical industry, and medical product industry. In particular, in one aspect of the hollow fiber membrane module using the composite hollow fiber membrane of the present invention, it is suitably used for filtration of a liquid to be treated containing an organic solvent and a solute, the liquid to be treated being used in electronic industries such as semiconductor and liquid crystal panel manufacturing. Examples of the organic solvent include a glycol ether-based solvent such as propylene glycol monomethyl ether, 3-methoxybutanol, propylene glycol monomethyl ether acetate, 3-methoxybutyl acetate, dipropylene glycol monomethyl ether acetate, diethylene glycol monoethyl ether and diethylene glycol monobutyl ether; a cyclic ketone such as cyclohexanone; and an aprotic polar solvent such as dimethyl sulfoxide and N-methylpyrrolidone. These organic solvents may be contained singly or in combination of two or more thereof.

### EXAMPLES

Hereinafter, the present invention will be more specifically described with reference to Examples. The present invention is not limited to these Examples.

### 1. Measurement Method

### [Outer Diameter and Inner Diameter of Polyamide Hollow Fiber Membrane]

Five composite hollow fiber membranes were observed with an optical microscope at a magnification of 200 times, the outer diameter and the inner diameter (at the portion having a maximum diameter) of the polyamide hollow fiber membrane constituting each composite hollow fiber membrane were measured, and each average value was obtained.

### [Porosity of Support Layer]

In a section of the composite hollow fiber membrane cut in a direction perpendicular to a longitudinal direction, scanning electron microscope (SEM) photographs of five points at equal intervals were taken in a thickness direction of the support layer of the polyamide hollow fiber membrane. Specifically, the photographs were taken as follows. FIG. 5 is a schematic sectional view of a polyamide hollow fiber membrane cut in a direction perpendicular to a longitudinal direction, and FIGS. 6 and 7 are partially enlarged views of a region surrounded by the dotted line in FIG. 5, showing an example of the polyamide hollow fiber membrane 8a including the dense layer 10 and the support layer 12. In FIGS. 5 to 7, the description of the silicone layer is omitted. As shown in FIG. 6, a straight line was drawn from the center of the lumen of the polyamide hollow fiber membrane 8a toward the outer surface, and the straight line was divided into five equal parts from the lumen surface to the outer surface of the support layer 12. Then, as illustrated in FIG. 6, the midpoint of each line segment divided into five equal parts was determined. Then, as illustrated in FIG. 7, photographs of five locations were taken at a magnification at which only the portion of the support layer 12 was included, and the number of pores was 30 to 300 with the midpoint positioned at the center of the captured image. The magnification was unified for the five locations. In the five SEM photographs that have been taken, image analysis of the region was performed using image analysis software (ImageJ), the pore portion and the polymer portion were distinguished through binarization processing, then the area ratio (%) of the total pore area to the analysis region area was calculated, and the average value thereof was calculated.

Specific operations with ImageJ were as follows. An image to be analyzed was captured in ImageJ, an analysis range was designated, a luminance value at which a peak of a histogram obtained through an operation of “Analyze>Histogram” was the highest was set as a threshold (that is, Lower threshold level was set to a luminance value at which the peak of the histogram was the highest, and Upper threshold level was set to 255), and the image was binarized at “Image>Adjust>Threshold”. Next, “Area” was checked at “Analyze>Set measurements”, and the entire area of the analysis range was determined through the operation of “Analyze>Measure”. Then, “Area” and “Limit to threshold” were checked at “Analyze>Set measurements”, and the operation of “Analyze>Measure” was performed again to calculate the areas of the polymer portion and the pore portion, and the area ratio (%) of the total pore area to the analysis region area was calculated.

### [Thickness of Dense Layer]

A section of the composite hollow fiber membrane cut in a direction perpendicular to a longitudinal direction was observed with a scanning electron microscope (SEM) at a magnification of 10,000 times. In the obtained SEM photograph, the distance (thickness) of a region where substantially no pores were observed in the polyamide hollow fiber membrane constituting the composite hollow fiber membrane was measured at 10 points at equal intervals, and the average value thereof was calculated.

[Molecular Weight Cut-Off of Polyamide Hollow Fiber Membrane (when Larger than 3000)]

First, a bundle in which 10 polyamide hollow fiber membranes cut into a length of 30 cm were put together was prepared. Next, a nylon hard tube having an outer diameter of 8 mm, an inner diameter of 6 mm, and a length of 50 mm was prepared, and a rubber plug having a length of about 20 mm was inserted from one end opening of the tube to plug the one end opening. Next, a two-liquid mixing type epoxy resin was injected from the opening of the connected tube on the side opposite to the side where the rubber plug was provided, and the tube inner space was filled with the epoxy resin. Thereafter, an end of the prepared bundle of the prepared polyamide hollow fiber membranes was thermally sealed so that the epoxy resin does not enter the hollow portion, the bundle was inserted into the tube filled with the epoxy resin until the tip of the end comes into contact with the rubber plug, and the epoxy resin was cured as it is. Next, the region on the rubber plug side of the cured epoxy resin portion was cut together with the tube to open the hollow portion. The same operation was performed for the other end, whereby the crossflow module 6 in which hollow portions at both ends of the polyamide hollow fiber membranes are open was produced.

The produced crossflow module 6 was connected to an internal pressure type separation processing line shown in FIG. 1, and a fluid liquid (feed solution) was caused to continuously pass through the crossflow module 6 with a liquid feeding circulation pump 2. As the fluid liquid, aqueous solutions containing 0.5 wt %, 0.5 wt %, 0.2 wt %, 0.2 wt %, or 0.4 wt % of five types of dextran having a molecular weight of 5000, 10,000, 40,000, 70,000, or 500,000, respectively, were used. The pressure of the primary pressure gauge 3 and the pressure of the secondary pressure gauge 4 were adjusted with the regulator 5 such that the arithmetic average value of the pressure of the primary pressure gauge 3 and the pressure of the secondary pressure gauge 4 was 1 bar. The fluid liquid that has passed through the pores of the polyamide hollow fiber membrane among the fluid liquid passing the inside of the module was recovered as a permeate separated from the fluid liquid, and the remaining fluid liquid was caused to circulate again to the separation processing line. The permeate flowing out of the crossflow module 6 after a lapse of two hours from the start of circulation was collected with the tray 7, the dextran concentration in the permeate was measured by high performance liquid chromatography, and the rejection rate at each molecular weight was calculated according to the following formula. Based on the result of the rejection rate with respect to dextran of each molecular weight, a graph showing the molecular weight of used dextran on the horizontal axis and the rejection rate on the vertical axis was created, and the molecular weight at the intersection of the resulting approximate curve and the rejection rate of 90% was defined as the molecular weight cut-off.

Solute rejection rate (%)={(dextran concentration in feed solution−dextran concentration in permeate)/dextran concentration in feed solution}×100

[Molecular Weight Cut-Off of Polyamide Hollow Fiber Membrane (when 3000 or Less)]

An NMP solution containing 0.05 wt % of each of four types of polystyrene having a molecular weight of 370, 1000, 2000, or 3000 was used as a fluid liquid, and the molecular weight cut-off was determined in the same manner as described above except that the arithmetic average value of the pressure of the primary pressure gauge 3 and the pressure of the secondary pressure gauge 4 was set to 15 bar, and the rejection rate was calculated according to the following formula.

Solute rejection rate (%)={(polystyrene concentration in feed solution−polystyrene concentration in permeate)/polystyrene concentration in feed solution}×100

### [Burst Pressure of Composite Hollow Fiber Membrane or Polyamide Hollow Fiber Membrane]

The module 8 illustrated in a of FIG. 2 was produced. First, a bundle in which 10 composite hollow fiber membranes or polyamide hollow fiber membranes 8a cut into a length of 30 cm were put together was prepared. Next, the nylon hard tube 8b having an outer diameter of 8 mm, an inner diameter of 6 mm, and a length of 50 mm was prepared, and a rubber plug having a length of about 20 mm was inserted from one end opening of the tube to plug the one end opening. Next, a two-liquid mixing type epoxy resin was injected from the opening of the tube on the side opposite to the side where the rubber plug is provided, and the tube inner space was filled with the epoxy resin. Thereafter, the prepared bundle of the composite hollow fiber membranes or polyamide hollow fiber membranes was bent into a substantially U shape, both ends of the composite hollow fiber membranes or polyamide hollow fiber membranes were thermally sealed so that the epoxy resin does not enter the hollow portion, the bundle was inserted into the tube filled with the epoxy resin until the tip of the end comes into contact with the rubber plug, and the epoxy resin was cured as it is. Then, the region on the rubber plug side of the cured epoxy resin portion was cut together with the tube, whereby the module 8 in which hollow portions at both ends of the composite hollow fiber membranes or polyamide hollow fiber membranes are open was produced.

Next, the module 8 was set in the apparatus illustrated in b of FIG. 2, water pressure was applied to the module 8 with the hand pump 9. The pressure at which the module 8 ruptures (burst pressure, unit: bar) was measured.

### [Thickness of Silicone Layer]

A section of the composite hollow fiber membrane cut in a direction perpendicular to a longitudinal direction was observed with a scanning electron microscope (SEM) at a magnification of 10,000 times. In the obtained SEM photograph, the distance (thickness) of the non-porous region present on the surface of the dense layer was measured at 10 points at equal intervals, and the average value thereof was calculated.

### [NMP Permeation Amount and Thinner Permeation Amount]

A bundle in which 20 composite hollow fiber membranes cut into a length of 30 cm were put together was prepared. Next, a polybutylene terephthalate (PBT) tube having an outer diameter of 12.7 mm, an inner diameter of 9.5 mm, and a length of 53 mm was prepared, a silicone tube having an inner diameter of 12 mm and a length of about 50 mm was inserted and connected to one end opening of the tube by about 15 mm, a rubber plug having a length of about 20 mm was inserted into the side opposite to the side where the silicone tube was inserted into the PBT tube, and the one end opening was plugged. Next, a two-liquid mixing type epoxy resin was injected from the opening of the connected tube on the side opposite to the side where the rubber plug was provided, and the tube inner space was filled with the epoxy resin. Thereafter, an end of the prepared bundle of the composite hollow fiber membranes was thermally sealed so that the epoxy resin did not enter the hollow portion, the bundle was inserted into the tube filled with the epoxy resin until the tip of the end came into contact with the rubber plug, and the epoxy resin was cured as it is. Next, the region on the rubber plug side of the cured epoxy resin portion was cut together with the tube to open the hollow portion. The same operation was performed for the other end, whereby a crossflow module in which hollow portions at both ends of the composite hollow fiber membranes are open was produced.

The produced crossflow module 6 was connected to an internal pressure type separation processing line shown in FIG. 1, and a fluid liquid was caused to continuously permeate the crossflow module 6 with a liquid feeding circulation pump 2. As the fluid liquid, NMP or a thinner (mixed liquid of 30 wt % of propylene glycol monomethyl ether acetate and 70 wt % of propylene glycol monomethyl ether) was used. In the module, the pressure of the primary pressure gauge 3 and the pressure of the secondary pressure gauge 4 were adjusted with the regulator 5 such that the arithmetic average value of the pressure of the primary pressure gauge 3 and the pressure of the secondary pressure gauge 4 was 90% with respect to the burst pressure of the composite hollow fiber membrane. The fluid liquid that has passed through the pores of the composite hollow fiber membrane among the fluid liquid passing the inside of the module was recovered as a permeate separated from the fluid liquid, and the remaining fluid liquid was caused to circulate again to the separation processing line. The permeate flowing out of the crossflow module 6 from 2 hours to 4 hours after the start of circulation was collected with the tray 7, and the NMP permeation amount or the thinner permeation amount (L/(m²·h)) was calculated according to the following calculation formula.

NMP permeation amount=volume (L) of NMP permeated to outside of composite hollow fiber membrane/[inner diameter (m) of composite hollow fiber membrane×3.14×effective filtration length (m) of composite hollow fiber membrane×20 (fibers)×time (h)]

Thinner permeation amount=volume (L) of thinner permeated to outside of composite hollow fiber membrane/[inner diameter (m) of composite hollow fiber membrane×3.14×effective filtration length (m) of composite hollow fiber membrane×20 (fibers)×time (h)]

The effective filtration length of the composite hollow fiber membrane is the length of a portion of the outer surface of the composite hollow fiber membrane that is not coated with the epoxy resin in the crossflow module.

### [Rejection Rate of Vitamin B₁₂]

The rejection rate of vitamin B₁₂ was measured in the same measurement procedure as in the above measurement of [NMP Permeation Amount and Thinner Permeation Amount] except that an NMP solution or a thinner solution containing 500 ppm of vitamin B₁₂ was used as the fluid liquid. The absorbances of the resulting permeate and fluid liquid at a wavelength of 550 nm were measured using an absorptiometer, and the rejection rate (%) of vitamin B₁₂ was calculated from the following formula.

Rejection rate of vitamin B₁₂=100−(absorbance of permeate/absorbance of fluid liquid)×100

### 2. Test Example

### Example 1

Chips of polyamide 6 (manufactured by Unitika Corporation, A1030BRT, relative viscosity 3.53) in an amount of 280 g and 720 g of dimethylsulfone (manufactured by Tokyo Chemical Industry Co., Ltd.) were stirred at 190 °C for 1.5 hours to be dissolved, and the stirring speed was reduced to defoam for 1 hour, whereby a membrane-forming dope solution was prepared. The membrane-forming dope solution was fed via a metering pump to a spinneret kept at 200 °C, and a mixed liquid of 70 wt % of polyethylene glycol 300 (PEG300) and 30 wt % of glycerol was caused to flow as the coagulation liquid for inside. The extruded membrane-forming dope solution was charged into a coagulation bath composed of a 60 wt % aqueous solution of 1,4-butylene glycol (1,4BG) at 5 °C, and cooled and solidified, whereby a polyamide porous membrane was formed. The wound polyamide porous membrane was immersed in water for 24 hours to perform solvent extraction (washing), and then dried by passing the membrane through a hot air dryer (inside temperature: 130 °C) without being stretched, whereby a polyamide hollow fiber membrane was obtained. The burst pressure and the molecular weight cut-off of the polyamide hollow fiber membrane were evaluated using the polyamide hollow fiber membrane.

A membrane bundle was prepared in which the obtained polyamide hollow fiber membranes were put together in a length of 40 cm and the number of 20. Next, a nylon hard tube having an inner diameter of 8 mm and a length of 50 mm was prepared, and a rubber plug having a length of about 20 mm was inserted from one end opening of the tube to plug the one end opening. Next, a two-liquid mixing type epoxy resin was injected from the opening of the tube on the side opposite to the side where the rubber plug is provided, and the tube inner space was filled with the epoxy resin. Thereafter, an end of the prepared polyamide hollow fiber membranes was thermally sealed, the polyamide hollow fiber membranes were inserted into the tube filled with the epoxy resin until the tip of the end came into contact with the rubber plug, and the epoxy resin was cured as it is. Next, the region on the rubber plug side of the cured epoxy resin portion was cut together with the tube to open the hollow portion of the polyamide hollow fiber membranes, whereby a silicone coating liquid injection module was obtained.

The main agent of a commercially available two-component mixed type silicone (product name: TSE3033, manufactured by Momentive Performance Materials Inc.) was diluted 10 times with ethyl acetate, and then the silicone coating liquid produced by mixing the curing agent in the same amount as the main agent was filled into a plastic syringe. The syringe and the silicone coating liquid injection module were connected with a silicone tube, and the silicone coating liquid was extruded into the hollow portion of the polyamide hollow fiber membranes at a linear velocity of 0.16 m/sec, that is, at a speed of 0.25 L/min. Next, the syringe was removed, and nitrogen blowing was performed at a linear velocity of 6.6 m/sec, that is, 10 L/min, followed by a curing treatment at 120 °C for 3 hours. Thereafter, the hollow fiber membranes were cut on the side of the epoxy resin portion of the injection module, whereby a composite hollow fiber membrane was obtained. The outer diameter and inner diameter of the polyamide hollow fiber membrane, the porosity of the support layer, the thickness of the dense layer, the burst pressure of the composite hollow fiber membrane, the thickness of the silicone layer, the NMP permeation amount, and the thinner permeation amount were evaluated using the composite hollow fiber membrane. Table 1 shows the measurement results in each of the measurements.

### Example 2

A composite hollow fiber membrane was manufactured in the same manner as in Example 1 except that in the preparation of a membrane-forming dope solution, 250 g of chips of polyamide 6 (manufactured by Unitika Corporation, A1030BRT, relative viscosity 3.53) and 750 g of dimethylsulfone (manufactured by Tokyo Chemical Industry Co., Ltd.) were stirred at 180 °C for 1.5 hours to be dissolved, and the stirring speed was reduced to defoam for 1 hour to prepare a membrane-forming dope solution. Table 1 shows the measurement results in each of the measurements.

### Example 3

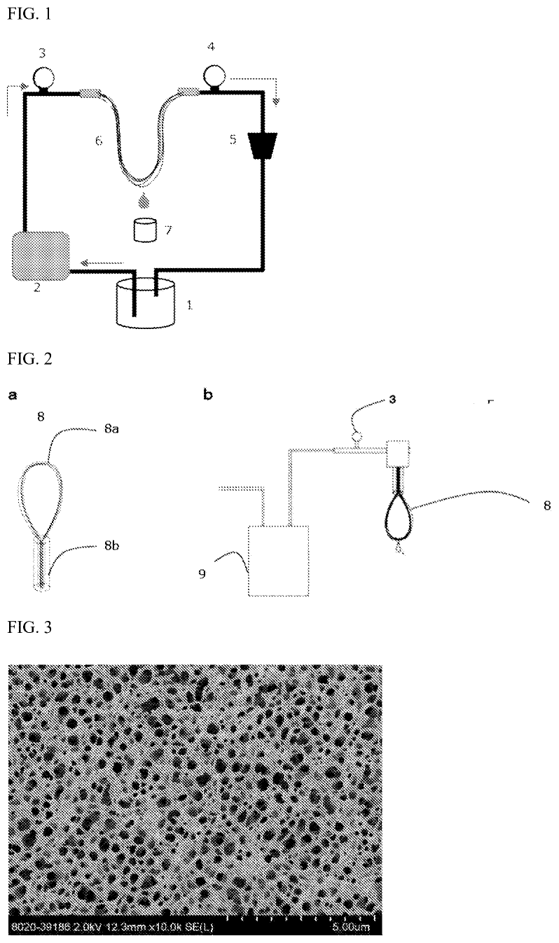

A composite hollow fiber membrane was manufactured in the same manner as in Example 1 except that in the preparation of a membrane-forming dope solution, 350 g of chips of polyamide 6 (manufactured by Unitika Corporation, A1030BRT, relative viscosity 3.53) and 650 g of dimethylsulfone (manufactured by Tokyo Chemical Industry Co., Ltd.) were stirred at 180 °C for 1.5 hours to be dissolved, and the stirring speed was reduced to defoam for 1 hour to prepare a membrane-forming dope solution. FIG. 3 is an image analysis view after binarization processing for calculating the porosity of the support layer of the obtained composite hollow fiber membrane. FIG. 4 is a scanning electron microscope image (magnification: 5000 times) of a lumen-side section of the obtained composite hollow fiber membrane. Table 1 shows the measurement results in each of the measurements.

### Example 4

A composite hollow fiber membrane was manufactured in the same manner as in Example 1 except that in the preparation of a membrane-forming dope solution, 280 g of chips of polyamide 6 (manufactured by Unitika Corporation, A1030BRT, relative viscosity 3.53) and 720 g of dimethylsulfone (manufactured by Tokyo Chemical Industry Co., Ltd.) were stirred at 180 °C for 1.5 hours to be dissolved, and the stirring speed was reduced to defoam for 1 hour to prepare a membrane-forming dope solution, polyethylene glycol 400 (PEG400) was used as the coagulation liquid for inside, and the obtained polyamide hollow fiber membrane was stretched by 1.5 times by passing the membrane through rolls of different speeds. Table 1 shows the measurement results in each of the measurements.

### Example 5

A composite hollow fiber membrane was manufactured in the same manner as in Example 1 except that in the preparation of a membrane-forming dope solution, 230 g of chips of polyamide 6 (manufactured by Unitika Corporation, A1030BRT, relative viscosity 3.53) and 770 g of dimethylsulfone (manufactured by Tokyo Chemical Industry Co., Ltd.) were stirred at 180 °C for 1.5 hours to be dissolved, and the stirring speed was reduced to defoam for 1 hour to prepare a membrane-forming dope solution. Table 1 shows the measurement results in each of the measurements.

### Comparative Example 1

A polyamide hollow fiber membrane (with no silicone layer) was manufactured in the same manner as in Example 3. Table 1 shows the measurement results in each of the measurements.

### Comparative Example 2

A polyamide hollow fiber membrane (with no silicone layer) was manufactured in the same manner as in Example 4. Table 1 shows the measurement results in each of the measurements.

### Comparative Example 3

A polyamide hollow fiber membrane (without silicone layer) was manufactured in the same manner as in Example 1 except that in the preparation of a membrane-forming dope solution, 280 g of chips of polyamide 6 (manufactured by Unitika Corporation, A1030BRT, relative viscosity 3.53) and 720 g of dimethylsulfone (manufactured by Tokyo Chemical Industry Co., Ltd.) were stirred at 180 °C for 1.5 hours to be dissolved, the stirring speed was reduced to defoam for 1 hour to prepare a membrane-forming dope solution, and a mixed liquid of 60 wt % of polyethylene glycol 300 (PEG300) and 40 wt % of glycerol was used as the coagulation liquid for inside. In the obtained polyamide hollow fiber membrane, no dense layer was observed, and the molecular weight cut-off was unmeasurable because a rejection rate of 90% was not achieved at any molecular weight. The estimated pore size with the bubble point method was equivalent to 5 nm.

Then, a silicone coating liquid was injected into the hollow portion of the obtained polyamide hollow fiber membrane in the same manner as in Example 1, and a curing treatment was performed, but a clear silicone layer was not observed. It is presumed that the silicone coating liquid penetrated into the support layer of the polyamide hollow fiber membrane, and thus a silicone layer was not formed. Table 1 shows the measurement results in each of the measurements.

TABLE 1

| | | | | | | | | | | | Composite hollow fiber membrane | | | | | | | |
|---|---|---|---|---|---|---|---|---|---|---|---|---|---|---|---|---|---|---|
| | | | | | | | | | | | | | Thinner permeation test | | | NMP permeation test | | |
| | Manufacturing condition of polyamide | | | | | | | | | | | | | | Re- | | | Re- |
| | hollow fiber membrane | | | | Polyamide hollow fiber membrane | | | | | | Thickness | | | | jection | | | jection |
| | Polyamide | Coagulation | | | | | Porosity of | Thickness | | Molecular | of | | Measure- | | rate of | Measure- | | rate of |
| | con- | liquid | | | Outer | Inner | support | of dense | Burst | weight | (μm) | Burst | ment | Permeation | vitamin | ment | Permeation | vitamin |
| | centration | for inside | Coagulation | | diameter | diameter | layer | layer | pressure | cut- | silicone | pressure | pressure | amount | B₁₂ | pressure | amount | B₁₂ |
| | (wt %) | (weight ratio) | bath | Stretching | (μm) | (μm) | (%) | (μm) | (bar) | off | layer | (bar) | (bar) | (L/(m² · h)) | (%) | (bar) | (L/(m² · h)) | (%) |
| Example | 28 | PEG300: | 60%-1, 4BG | None | 780 | 450 | 73 | 0.54 | 20 | 60000 | 4.4 | 20 | 18.0 | 2.4 | 99 | 18.0 | 2.0 | 99 |
| 1 | | glycerol = 7:3 | | | | | | | | | | | | | | | | |
| Example | 25 | PEG300: | 60%-1, 4BG | None | 770 | 440 | 75 | 0.42 | 16 | 50000 | 3.2 | 16 | 14.4 | 2.4 | 99 | 14.4 | 1.7 | 99 |
| 2 | | glycerol = 7:3 | | | | | | | | | | | | | | | | |
| Example | 35 | PEG300: | 60%-1, 4BG | None | 780 | 440 | 68 | 0.78 | 31 | 60000 | 3.4 | 31 | 27.9 | 4.2 | 99 | 27.9 | 3.2 | 99 |
| 3 | | glycerol = 7:3 | | | | | | | | | | | | | | | | |
| Example | 28 | PEG400 | 60%-1, 4BG | 1.3 | 820 | 370 | 72 | 1.0 | 20 | 1000 | 4.0 | 20 | 18.0 | 1.9 | 99 | 18.0 | 1.5 | 99 |
| 4 | | | | times | | | | | | | | | | | | | | |
| Example | 23 | PEG300: | 60%-1, 4BG | None | 760 | 430 | 76 | 0.3 | 12 | 50000 | 3.6 | 12 | 10.8 | 1.8 | 99 | 10.8 | 1.3 | 99 |
| 5 | | glycerol = 7:3 | | | | | | | | | | | | | | | | |
| Com- | 35 | PEG300: | 60%-1, 4BG | None | 780 | 440 | 68 | 0.78 | 31 | 50000 | — | 31 | 27.9 | 19.9 | 0 | 27.9 | 17.9 | 0 |
| parative | | glycerol = 7:3 | | | | | | | | | | | | | | | | |
| Example | | | | | | | | | | | | | | | | | | |
| 1 | | | | | | | | | | | | | | | | | | |
| Com- | 28 | PEG400 | 60%-1, 4BG | 1.3 | 820 | 370 | 72 | 1.0 | 20 | 1000 | — | 20 | 18.0 | 2.9 | 89 | 18.0 | 2.3 | 88 |
| parative | | | | times | | | | | | | | | | | | | | |
| Example | | | | | | | | | | | | | | | | | | |
| 2 | | | | | | | | | | | | | | | | | | |
| Com- | 28 | PEG300: | 60%-1, 4BG | None | 760 | 440 | 73 | — | 20 | — | — | 20 | 18.0 | 36 | 0 | 18.0 | 32.4 | 0 |
| parative | | glycerol = 6:4 | | | | | | | | | | | | | | | | |
| Example | | | | | | | | | | | | | | | | | | |
| 3 | | | | | | | | | | | | | | | | | | |

The composite hollow fiber membranes of Examples 1 to 5, provided with a silicone layer on a surface of the dense layer of the polyamide hollow fiber membrane, had a rejection rate of vitamin B₁₂ of 99%, having a high rejection ability at nanofiltration level. The membranes achieved the liquid permeability of both the thinner and NMP and the rejection ability of vitamin B₁₂ at a high level. On the other hand, the polyamide hollow fiber membranes of Comparative Examples 1 to 3, not provided with a silicone layer, had a rejection rate of vitamin B₁₂ of 0% or in the 80% range, and the membranes were not able to be used as a filtration membrane at a nanofiltration level.

### REFERENCE SIGNS LIST

1 Fluid liquid tank
2 Liquid feeding pump
3 Primary pressure gauge
4 Secondary pressure gauge
5 Regulator
6 Crossflow module
7 Tray
8 Burst pressure evaluation module
8a Polyamide hollow fiber membrane
8b Nylon hard tube
9 Hand pump
10 Dense layer
11 Silicone layer
12 Support layer

1. A composite hollow fiber membrane comprising:
a polyamide hollow fiber membrane including a dense layer and a support layer; and
a silicone layer,
wherein the silicone layer is provided on a surface of the dense layer.

2. The composite hollow fiber membrane according to claim 1, wherein the support layer has a porosity of 60 to 80%.

3. The composite hollow fiber membrane according to claim 1, wherein the dense layer has a thickness of 0.1 μm or more.

4. The composite hollow fiber membrane according to claim 1, wherein the dense layer is provided on a lumen surface side of the polyamide hollow fiber membrane.

5. The composite hollow fiber membrane according to claim 1, wherein the silicone layer has a thickness of 0.2 to 10 μm.

6. The composite hollow fiber membrane according to claim 1, wherein the silicone layer is formed of silicone rubber.

7. A filtration method comprising filtering a liquid to be treated containing an organic solvent and a solute using the composite hollow fiber membrane according to claim 1.

8. A hollow fiber membrane module comprising the composite hollow fiber membrane according to claim 1 housed in a module case.

9. A method for manufacturing a composite hollow fiber membrane, the method comprising first to fourth steps described below:
a first step of preparing a membrane-forming dope solution in which a polyamide resin is dissolved at a concentration of 20 wt % or more at a temperature of 100 °C or higher in an organic solvent having a boiling point of 150 °C or higher and incompatible with the polyamide resin at a temperature of lower than 100 °C;
a second step of extruding the membrane-forming dope solution into a coagulation bath at 100 °C or lower in a predetermined shape to coagulate the polyamide resin into a membrane shape, wherein in the step, a coagulation liquid having compatibility with the organic solvent used in the membrane-forming dope solution and low affinity for the polyamide resin is brought into contact with at least one surface of the membrane-forming dope solution extruded in the predetermined shape to form a polyamide hollow fiber membrane having a dense layer on the at least one surface;
a third step of removing the solvent of the membrane-forming dope solution and the coagulation liquid from the polyamide hollow fiber membrane formed in the second step; and
a fourth step of forming a silicone layer on a surface of at least one dense layer of the polyamide hollow fiber membranes obtained by performing the third step.
